(19) United States
(12) Patent Application Publication
(10) Pub. No.: US 2016/0282599 A1
(43) Pub. Date: Sep. 29, 2016

(54) SYSTEMS AND METHODS FOR COMBINING MAGNIFIED IMAGES OF A SAMPLE

(71) Applicant: Syntheslide, LLC, Royal Oak, MI (US)

(72) Inventors: Nakul Shankar, Midland, MI (US); Austin McCarty, Sterling Heights, MI (US)

(21) Appl. No.: 15/083,002

(22) Filed: Mar. 28, 2016

Related U.S. Application Data
(60) Provisional application No. 62/139,634, filed on Mar. 27, 2015.

(51) Int. Cl. G02B 21/36; G06T 7/00; G06T 3/40

(52) U.S. Cl. CPC G02B 21/367; G06T 3/4038; G06T 7/0014; G06T 2207/10056; G06T 2207/20048; G06T 2207/20221; G06T 2207/30024

(57) ABSTRACT

Embodiments of the present disclosure relate to obtaining magnified images of a sample and combining the magnified images to create a combined magnified image. In an embodiment, a system includes an ocular device including at least one lens used to magnify portions of a sample. The system also includes a detector configured to detect the magnified portions and produce magnified images of the magnified portions. A processing device is coupled to the detector. The processing device is configured to: determine a transformation function for the at least one lens; receive two or more magnified images; apply the transformation function to the received magnified images; and combine the transformed magnified images into a combined image.

### CROSS-REFERENCE TO RELATED APPLICATIONS

This application claims priority to U.S. Provisional Patent Application No. 62/139,634, filed Mar. 27, 2015, entitled “CAMERA MOUNT FOR MICROSCOPE,” which is hereby incorporated herein by reference in its entirety.

### TECHNICAL FIELD

Embodiments of the present disclosure generally relate to imaging samples. More specifically, embodiments of the disclosure relate to obtaining magnified images of a sample and combining the magnified images to create a combined magnified image of the sample.

### BACKGROUND

Pathologists study tissue, cell and/or body fluid samples (collectively referred to as a “sample”) taken from a patient and/or cadaver to determine whether one or more abnormalities are present in the sample. One or more abnormalities may be indicative of a disease or cause of death. Typical diseases that a pathologist may determine to be present may include, but are not limited to, diseases related to one or more organs, blood and/or other cellular tissue.

In pathology, whole-slide imaging systems may be used to create images a sample. The whole-slide imaging systems may produce one or more magnified images of the sample, which a pathologist can examine to formulate an opinion of the sample. In some situations, the pathologist may be located offsite from the whole-slide imaging system that is used to produce the magnified images of the sample. As such, the magnified images may need to be sent to the pathologist, at another location, for examination.

### SUMMARY

Embodiments of the disclosure relate to obtaining magnified images of a sample and combining the magnified images to create a combined magnified image.

In an embodiment of the disclosure, a system comprises: an ocular device including at least one lens used to magnify portions of a sample; a detector configured to detect the magnified portions and produce magnified images of the magnified portions; and a processing device communicatively coupled to the detector, the processing device configured to: determine a transformation function for the at least one lens; receive two or more magnified images; apply the transformation function to the received magnified images; and combine the transformed magnified images into a combined image.

In another embodiment of the disclosure, a method comprises: receiving magnified images of portions of a sample, the images being magnified by at least one lens; determining a transformation function for the at least one lens; applying the transformation function to two or more magnified images of the received magnified images; and combining the two or more transformed images into a combined image.

In another embodiment of the disclosure, a non-transitory tangible computer-readable storage medium having executable computer code stored thereon, the code comprising a set of instructions that causes one or more processors to perform the following: receive magnified images of a sample; receive a magnified image of a calibration grid; determine parameters of the received magnified image of the calibration grid; compare the determined parameters to known parameters of the calibration grid; determine a transformation function based on the comparison; and apply the transformation function to the received magnified images the sample.

While multiple embodiments are disclosed, still other embodiments of the disclosed subject matter will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 shows an illustrative system for slide imaging, in accordance with embodiments of the disclosure.

FIG. 2 is a block diagram of an illustrative computing device for slide imaging, in accordance with embodiments of the disclosure.

FIGS. 3A-3B are images of portions of an illustrative adaptor, in accordance with embodiments of the disclosure.

FIG. 4 is an isometric view of an image of an illustrative adaptor coupled to an ocular device, in accordance with embodiments of the disclosure.

FIG. 5 is a top view of an image of an illustrative adaptor coupled to a computing device, in accordance with embodiments of the disclosure.

FIG. 6 is a front view of an image of another illustrative adaptor, in accordance with embodiments of the disclosure.

FIGS. 7A-7C are images of illustrative magnified calibration grids, in accordance with embodiments of the disclosure.

FIG. 8 is an illustrative scouting image, in accordance with embodiments of the disclosure.

FIGS. 9A-9B are illustrative magnified images of portions of a sample, in accordance with embodiments of the disclosure.

FIG. 10 is an illustrative magnified image of a portion of a sample that includes detected features, in accordance with embodiments of the disclosure.

FIG. 11 is an image including illustrative magnified images of portions of a sample that include detected features, in accordance with embodiments of the disclosure.

FIG. 12 is an image including illustrative magnified images of portions of a sample that includes paths indicative of how to piece together the portions of the sample, in accordance with embodiments of the disclosure.

FIG. 13 is an illustrative combined image of a sample, in accordance with embodiments of the disclosure.

FIG. 14 is a flow diagram of an illustrative method for combining magnified images of a sample, in accordance with embodiments of the disclosure.

FIGS. 15A-15D are illustrative magnified images of portions of an eye, in accordance with embodiments of the disclosure.

FIG. 16 is an illustrative combined image of a portion of an eye, in accordance with embodiments of the disclosure.

FIG. 17 is an illustrative image of an inside of an ear, in accordance with embodiments of the disclosure.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

Although the term “block” may be used herein to connote different elements illustratively employed, the term should not be interpreted as implying any requirement of, or particular order among or between, various steps disclosed herein unless and except when explicitly referring to the order of individual steps.

### DETAILED DESCRIPTION

Embodiments of the disclosure relate to obtaining magnified images of a sample and combining the magnified images to create a combined magnified image. As stated above, whole-slide imaging systems may be used to image a sample and the imaged sample can be used for pathological purposes. Conventional whole-slide imaging systems, however, typically have one or more limitations.

For example, some conventional whole-slide imaging systems can be expensive. As such, many medical institutions do not have digital pathology budgets that allow the institutions to purchase these expensive conventional whole-slide imaging systems. Furthermore, the institutions that can afford to buy one of these whole-slide imaging systems may only be able to afford one or two systems. As a result, there can be a long queue to use the one or two systems.

The reason why many conventional whole-slide imaging systems can be expensive is, in part, because they may require a line-scan camera. Line-scan cameras may be required by some conventional whole-slide imaging systems to produce diagnostic quality images. In addition to being expensive, line scan cameras can be large, cumbersome and difficult to use.

Other conventional whole-slide imaging systems that use smaller cameras may have limitations as well. For example, conventional whole-slide imaging systems that use smaller cameras oftentimes do not produce diagnostic quality magnified images that can be used for pathological purposes. As such, a hospital may have to trade quality for price or vice-versa.

The embodiments presented herein may reduce some of these limitations associated with conventional whole-slide imaging systems.

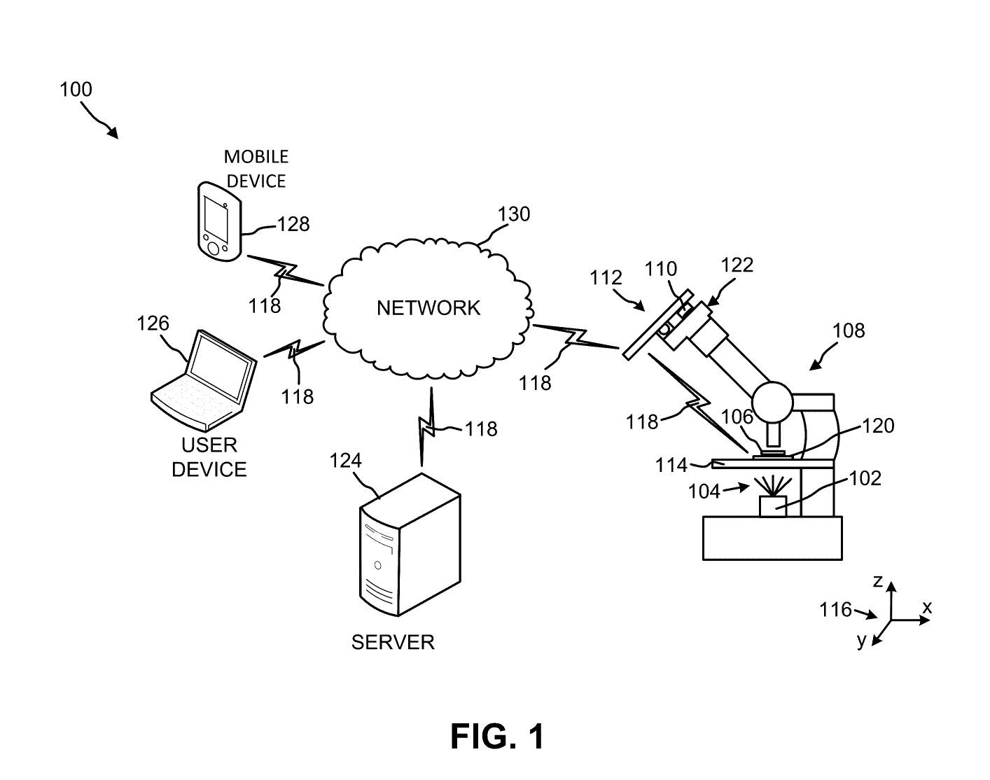

FIG. 1 shows an illustrative system 100 for slide imaging, in accordance with embodiments of the disclosure. In embodiments, the system 100 includes a light source 102 (e.g., a light bulb, a photon beam, ambient light and/or the like) that emits light 104. In embodiments, the amount of light 104 emitted from the light source 102 may be configurable. Some of the light 104 emitted by the light source 102 passes through a first portion of a sample 106 and into the ocular device 108. In embodiments, the ocular device 108 includes one or more lenses (not shown), that focus the light 104 passing through the first portion, in order to produce a magnified view of the first portion of the sample 106. In embodiments, the sample 106 may be any type of sample that one may want to view through an ocular device 108. For example, the sample 106 may be a biopsy sample that a pathologist and/or other medical professional would view in the course of his or her practice. In embodiments, the sample 106 may be located on a slide, so that the likelihood of the sample 106 being degraded is decreased. In embodiments, the ocular device 108 is a microscope, for example, the microscope that a pathologist and/or other medical professional may use to view a sample 106. Since microscopes are well known, they are not discussed in greater detail herein.

After the light 104 passes through the ocular device 108, the light 104 is received by the detector 110. When receiving the light 104, the detector 110 may store the light 104 in memory as an image. In embodiments, the memory may be included in a computing device 112 that is coupled to the detector 110.

In embodiments, the memory of the computing device 112 may include computer-executable instructions that, when executed by one or more program components, cause the one or more program components of the computing device 112 to perform one or more aspects of the embodiments described herein. Computer-executable instructions may include, for example, computer code, machine-useable instructions, and the like such as, for example, program components capable of being executed by one or more processors associated with the computing device 112. Program components may be programmed using any number of different programming environments, including various languages, development kits, frameworks, and/or the like. Some or all of the functionality contemplated herein may also, or alternatively, be implemented in hardware and/or firmware.

The computer-executable instructions may be part of an application that can be installed on the computer device 112. In embodiments, when the application is installed on the computing device 112 and/or when the application is run, the application may determine whether the computing device 112 satisfies a set of minimum requirements. The minimum requirements may include, for example, determining the computing device's 112 processing capabilities, operating system and/or the detector's 110 technical specifications. For example, computing devices 112 that have processors with speeds greater than or equal to 500 Megahertz (MHz) and have 256 Megabytes (MB) (or greater) of Random Access Memory (RAM) may satisfy some of the minimum requirements. As another example, computing devices 112 that have WiFi and Bluetooth capabilities and include an on-board gyroscope, accelerometer and temperature sensor, for measuring the operating temperature of the computing device 112, may satisfy some of the minimum requirements. As even another example, a computing device 112 that does not include a program preventing root access of the computing device 112 may satisfy some of the minimum requirements. As even another example, detectors 110 that include an 8 megapixel (MP) (or greater) sensor may satisfy some of the minimum requirements. In embodiments, the set of minimum requirements may be the requirements to produce diagnostic quality magnified images of the sample 106. The minimum requirements listed above, however, are only examples and not meant to be limiting. In embodiments, if a computing device 112 does not satisfy one or more of the minimum requirements, the application installed on the computing device 112 may be programmed to include a visual identifier (e.g., a watermark) on any image produced by the computing device 112.

In embodiments, the technical specifications of the computing device 112 (e.g., the computing device's processing capabilities and operating system) and/or detector 110 may be transferred to a server 124, user device 126, and/or mobile device 128 via a network 130 for storage and/or identification of the computing device 112.

In embodiments, the computing device 112 may measure the lumens of a first magnified image detected by the detector 110. The lumens may be used to generate a luminosity histogram. The luminosity histogram may be used to determine the brightness distribution of the first magnified image. The lumens and/or luminosity histogram may be used to conform, within a certain percentage (e.g., 1%, 5%, 10%), the luminosity of other magnified images detected by the detector 110 to the first magnified image. For example, based on the lumens and/or the luminosity histograms of the first magnified image, the application may adjust the ISO, the shutter speed, the white balance of the detector 110 and/or direct the computing device 112 to send a signal to the light source 102 to adjust the output of the light source 102 (assuming the light source 102 is capable of receiving a signal from the computing device 112) when the detector 110 is detecting other magnified images. In embodiments, each magnified image may be conformed to the standard luminosity of the first magnified image so that the when the magnified images are combined into a combined image, as discussed below, the combined image may appear more uniform and be of higher quality.

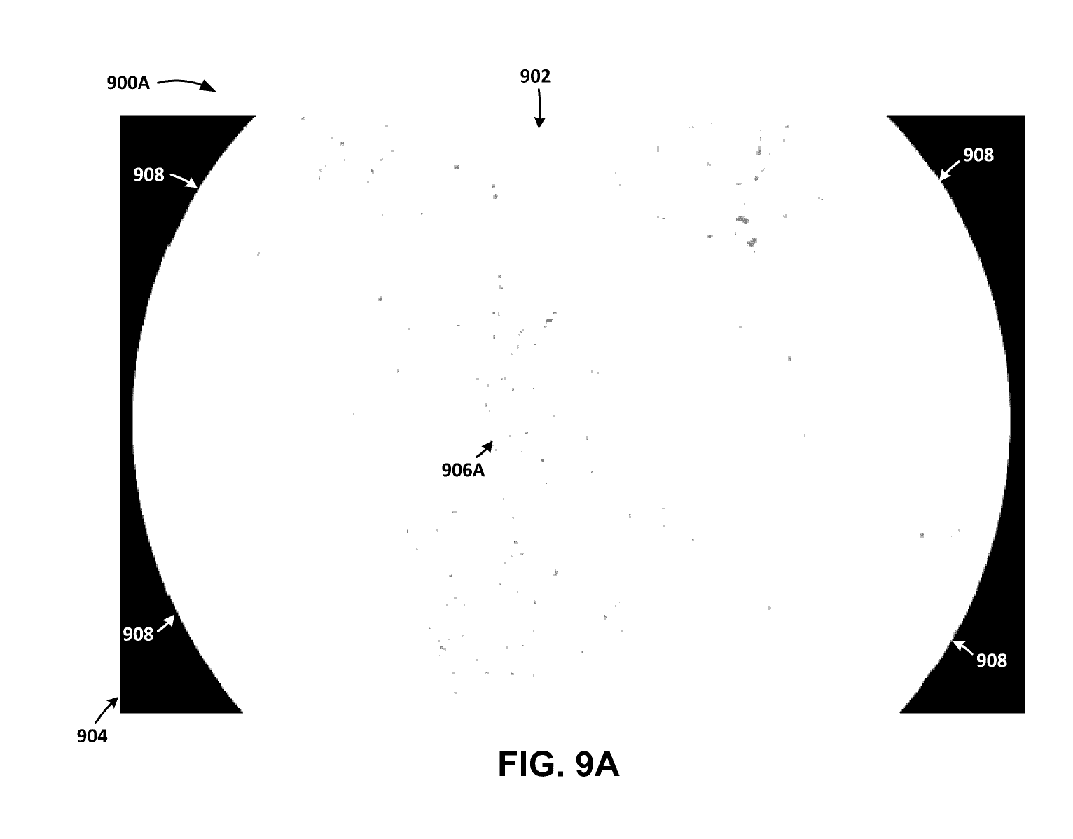

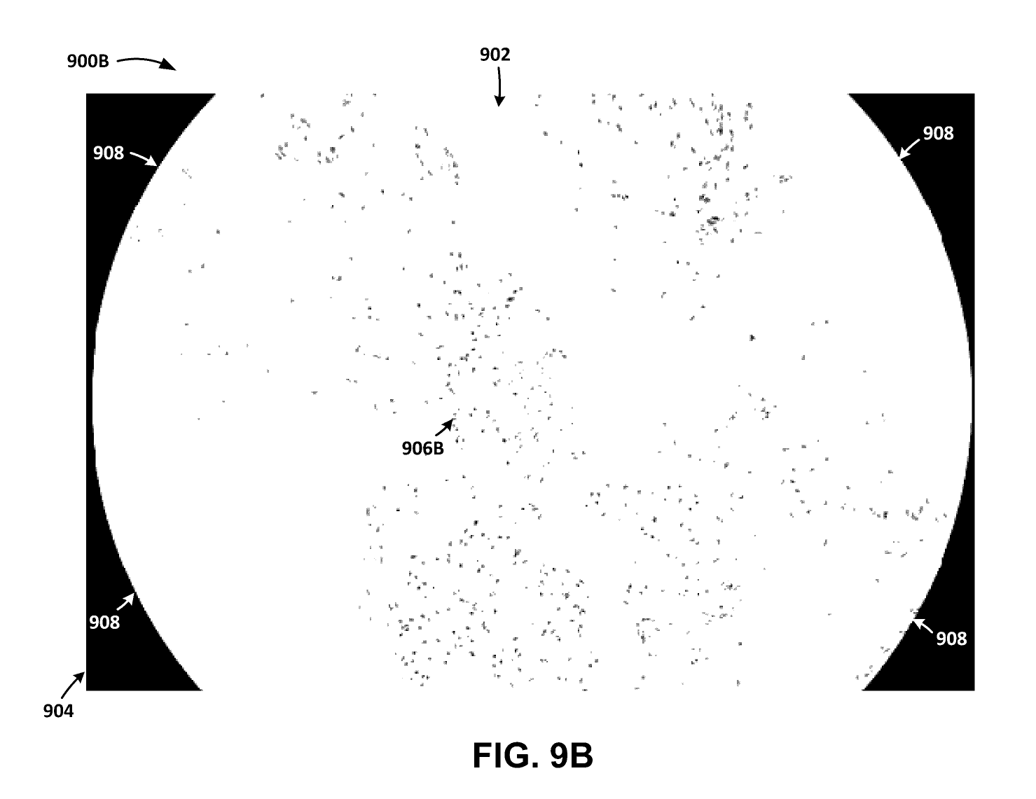

To obtain a diagnostic quality magnified image of the sample 106, one or more components of the ocular device 108 may be adjusted so that the detector 110 receives an in-focus magnified image of the first portion of the sample 106. In embodiments, the platform 114 may be adjusted up or down, so that the first portion of the sample 106 is in focus. That is, the platform 114 may be adjusted along the z-axis of the coordinate system 116. To determine when the sample 106 is in focus, the computing device 112 may determine that, at a specific z-position of the z-axis, the intensity of one or more features in the detected image of the sample 106 and/or a gradient of a neighborhood of pixels decreases when the platform 114 is adjusted in either direction along the z-axis of the coordinate system 116. This z-position may be the z-position where the sample 106 is in focus. In embodiments, the one or more features may be determined using Corner Detection (e.g., Harris Corner Detection), as discussed in more detail below. In embodiments, the adjustment of the platform 114 may be controlled by the computing device 112 via a communication link 118. In other embodiments, the adjustment of the platform 114 may be controlled manually by a user. A more detailed discussion of producing an in-focus magnified image is discussed in reference to FIGS. 9A-9B below.

In embodiments, the detector 110 may be an 8 MP (or greater) sensor that is included in a digital camera. By being an 8 MP (or greater) sensor, the detector 110 is able to detect features of the sample 106 and produce high-quality diagnostic magnified images. In embodiments, however, the detector 110 may be less than an 8 MP sensor and/or be another type of sensor. In embodiments, the digital camera that includes the detector 110 may be capable of a shutter speed of at least 1/1000 seconds. Other exemplary shutter speeds include, but are not limited to, 1/2000 seconds, 1/3000 seconds 1/4000 seconds, and/or the like. However, these are only examples. Accordingly, the shutter speed may be less than 1/1000 and/or include other shutter speeds not listed. Since detectors 110 used to produce images (e.g., the detectors used in digital cameras) are well known, they are not discussed in greater detail herein.

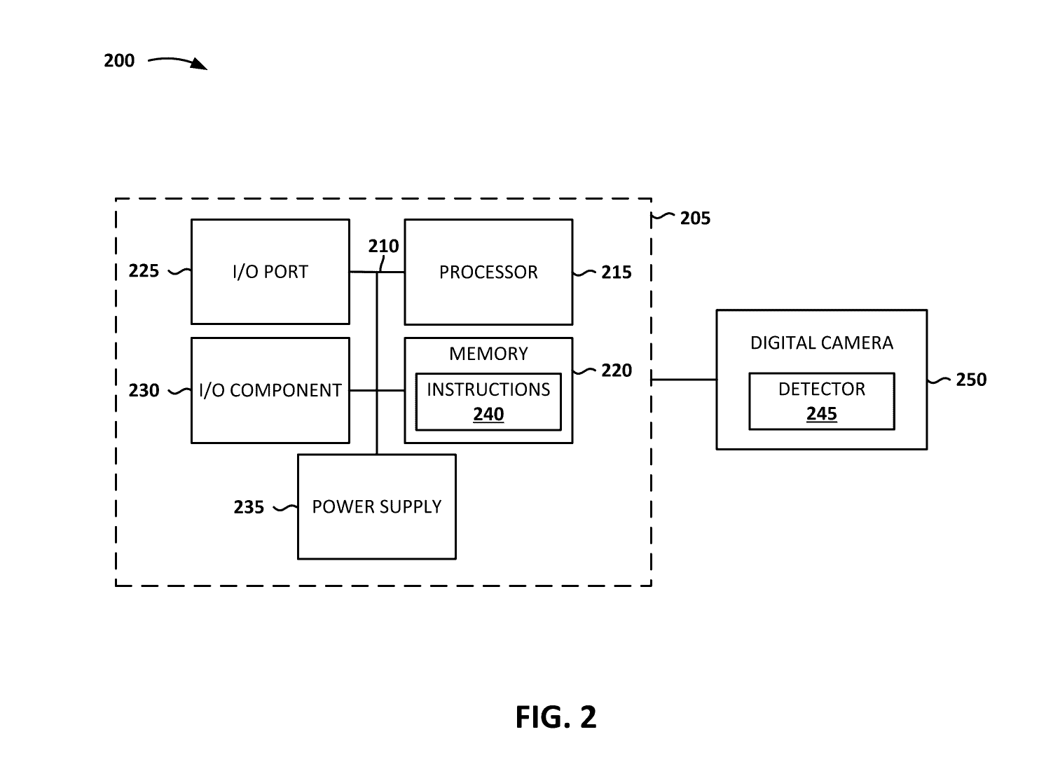

As stated above, in embodiments, the detector 110 may be coupled to and/or incorporated into a computing device 112. In embodiments, the computing device 112 may be a smartphone, tablet or other smart device (e.g., an iPhone, iPad, iPod, a device running the Android operating system, a Windows phone, a Microsoft Surface tablet and/or a Blackberry). The components includes in an illustrative computing device 112 are discussed in more detail in reference to FIG. 2 below.

In embodiments, the communication link 118 may be, or include, a wired communication link and/or a wireless communication link such as, for example, a short-range radio link, such as Bluetooth, IEEE 802.11, a proprietary wireless protocol, and/or the like. In embodiments, for example, the communication link 118 may utilize Bluetooth Low Energy radio (Bluetooth 4.1), or a similar protocol, and may utilize an operating frequency in the range of 2.40 to 2.48 GHz. The term “communication link” may refer to an ability to communicate some type of information in at least one direction between at least two components and/or devices, and should not be understood to be limited to a direct, persistent, or otherwise limited communication channel. That is, according to embodiments, the communication link 118 may be a persistent communication link, an intermittent communication link, an ad-hoc communication link, and/or the like. The communication link 118 may refer to direct communications between the computing device 112 and other components of system 100 (e.g., the platform 114 and/or the slide displacement unit 120, as discussed below) and/or indirect communications that travel between the computing device 112 and other components of the system 100 via at least one other device (e.g., a repeater, router, hub, and/or the like). The communication link 118 may facilitate uni-directional and/or bi-directional communication between the computing device 112 and other components of the system 100. Data and/or control signals may be transmitted between the computing device 112 and other components of the system 100 to coordinate the functions of the computing device and other components of the system 100.

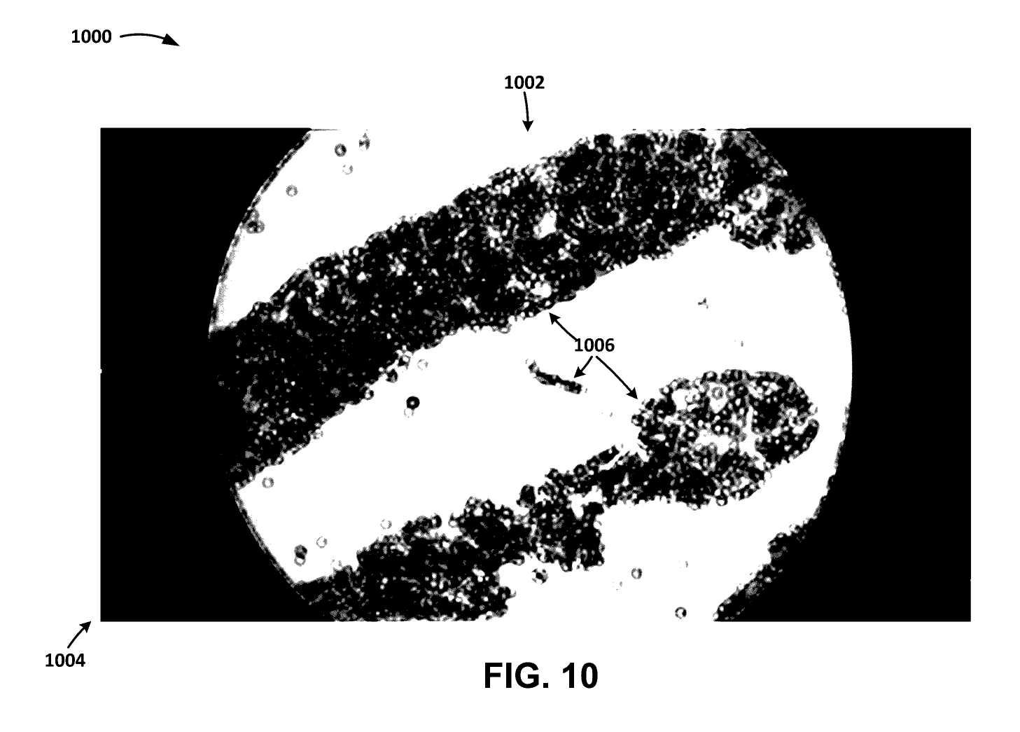

After a magnified image of the first portion of the sample 106 is obtained, the sample 106 is shifted so that the light 104 passes through a second portion of the sample 106. The detector 110 then receives the light 104 that passes through the second portion of the sample 106. In embodiments, before obtaining a magnified image of a second portion, one or more components (e.g., the platform 114) of the ocular device 108 may be adjusted so that the detector 110 receives an in-focus magnified image of the second portion of the sample 106, as discussed above and as discussed in reference to FIGS. 9A-9B below. Furthermore, one or more components of the detector 108 may be adjusted so that the magnified image of the second portion of the sample 106 has a similar luminosity as the first portion of the sample 106, as discussed above. In embodiments, the first and second portions overlap. As such, there may be some features of the sample 106 that are included in both the first and second portions, as discussed in more detail in reference to FIGS. 10-12 below. After a magnified image of the second portion is obtained, the sample 106 may be shifted to capture a magnified image of third portion. In embodiments, this process may continue until magnified images of all of portions of the sample 106 are obtained by the detector 110 and stored in memory (e.g., memory of the computing device 112).

To shift the sample 106, a slide displacement mechanism 120 may be used. In embodiments, the slide displacement mechanism 120 is capable of being displaced in one or more horizontal directions relative to the light source 102. That is, in embodiments, the slide displacement mechanism may be displaced along the x-axis, the y-axis and/or a combination thereof of the coordinate system 116. In embodiments, the slide displacement mechanism 120 may be incorporated into the platform 114 and communicatively coupled to the computing device 112 via the communication link 118. As such, the computing device 112 may control the movement of the slide displacement mechanism 120 in order to facilitate the imaging of the sample 106, as discussed herein.

Alternatively, the sample 106 may be shifted manually. In these embodiments, the computing device 112 may coordinate with the person shifting the sample 106 through one or more indicia. For example, the computing device 112 may output a sound, a visual indicator, visual instructions and/or audio instructions indicating which direction to move the sample 106 and/or when to stop moving the sample 106. When the computing device 112 determines that the sample 106 has been imaged and/or the relevant portions of the sample 106 have been imaged, the computing device 112 may output a sound, a visual indicator, visual instructions and/or audio instructions indicating that the process is complete.

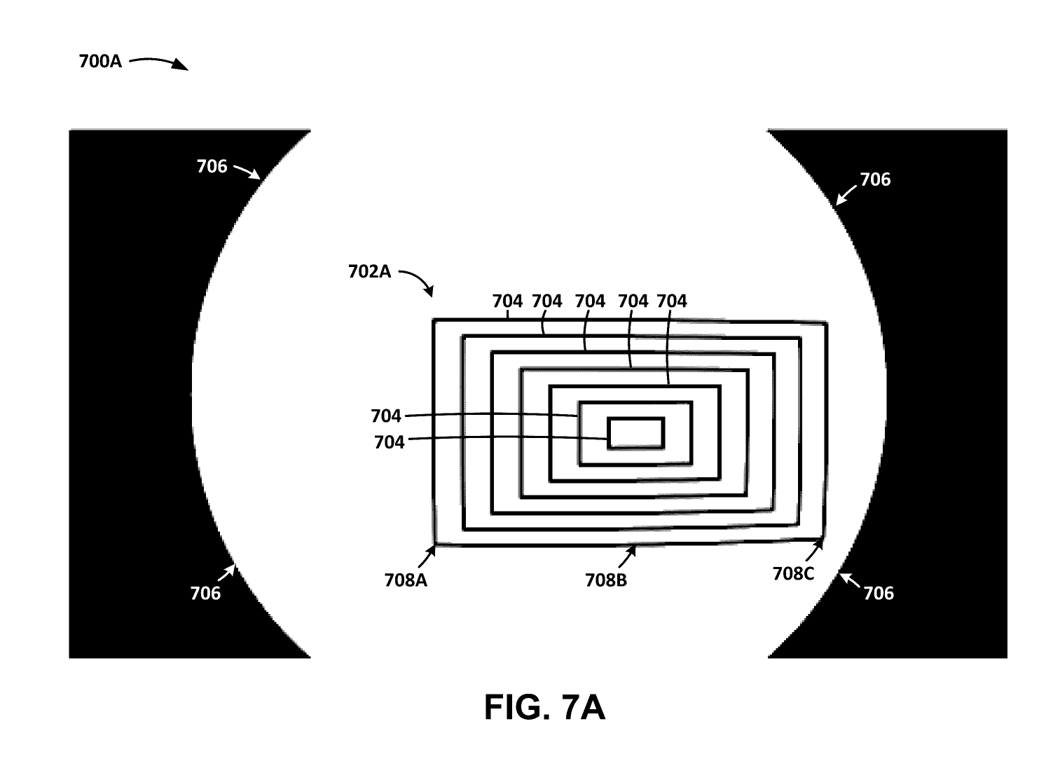

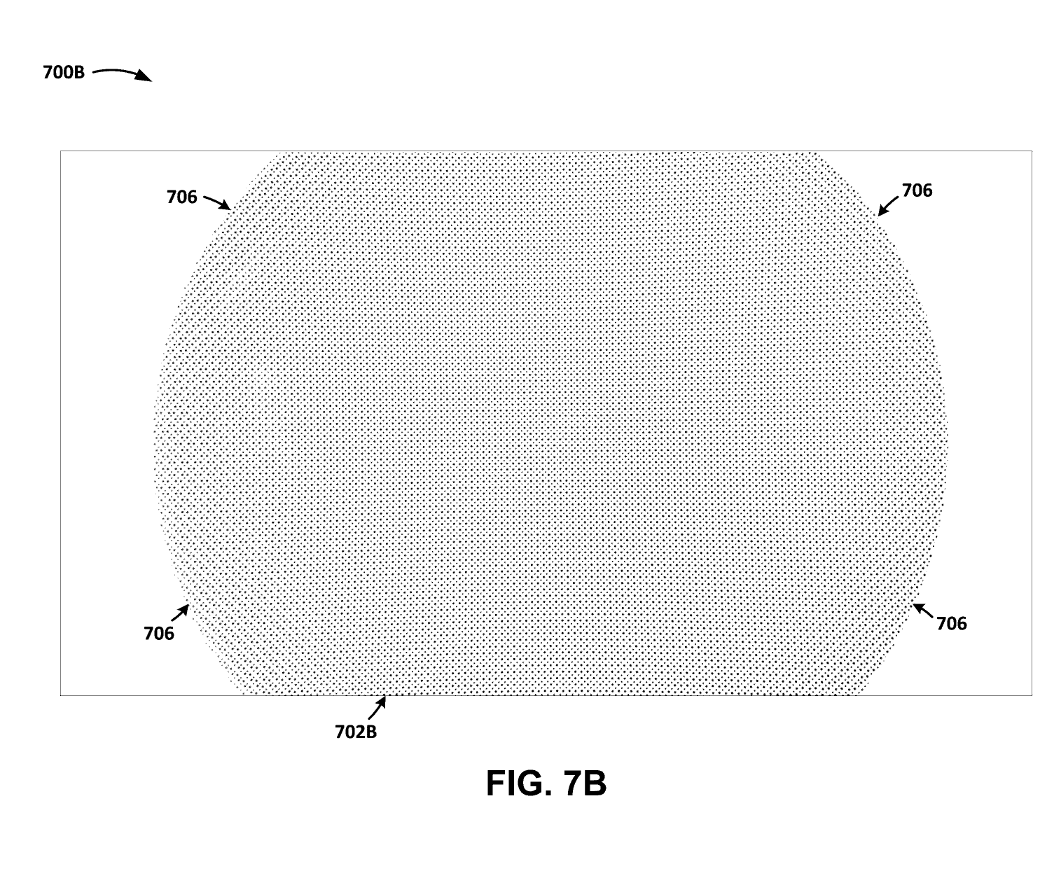

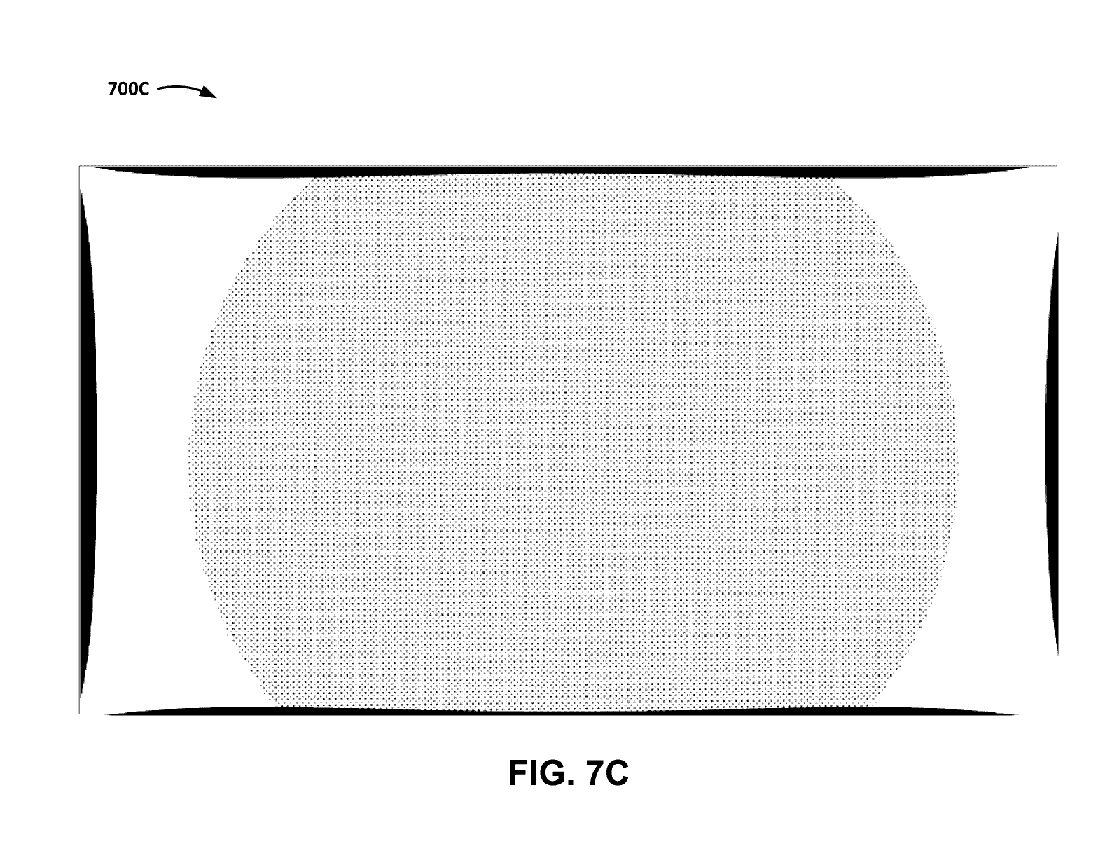

In embodiments, before and/or after obtaining any magnified images of the sample 106, a calibration grid may be used to determine a transformation function. The transformation function may be used to reduce distortion caused by the curvature of the one or more lenses of the ocular device 108. The calibration grid and reduction of distortion caused by the curvature of the one or more lenses is discussed in more detail in reference to FIGS. 7A-7C below.

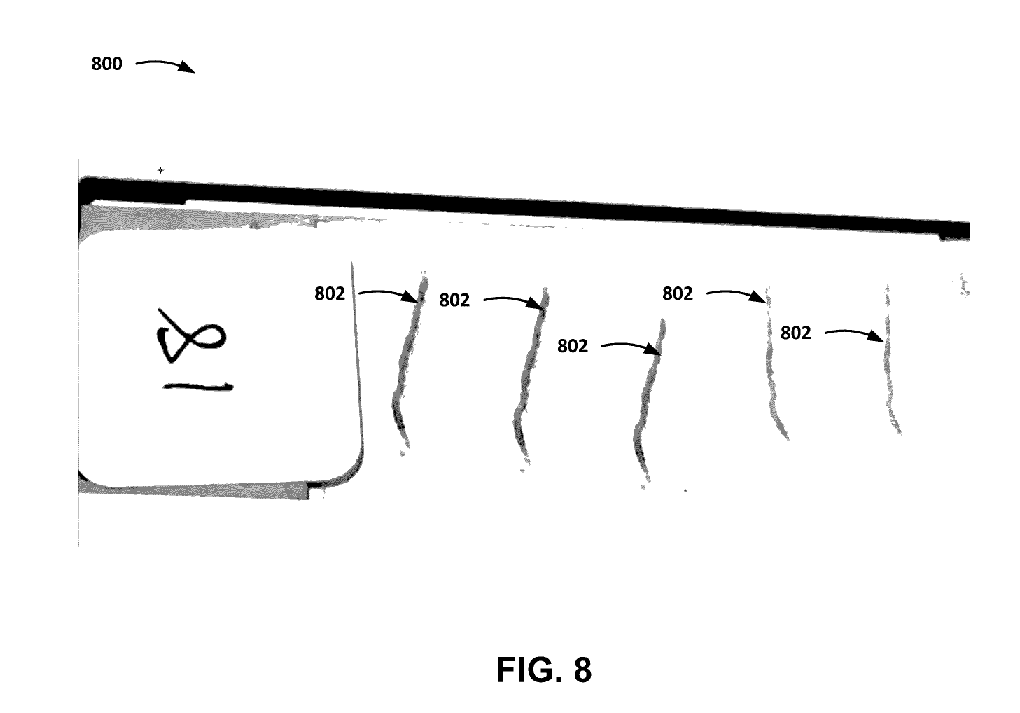

In embodiments, one or more scouting images of the entire sample 106 may be obtained by the detector 110 and stored in memory (e.g., the memory of the computing device 112). In embodiments, the scouting image may be an entire image of the slide and/or sample 106. Obtaining a scouting image facilitates determining the dimensions of the slide (assuming the sample 106 is on a slide), dimensions of the sample 106 on the slide, the positions of features included in the sample 106 and/or to detect any printed text on the slide itself. Printed text on the slide may be used to retrieve information about the slide (e.g., how the sample 106 on the slide fits into a larger biopsy of tissue). An illustrative scouting image is discussed in more detail in reference to FIG. 8 below.

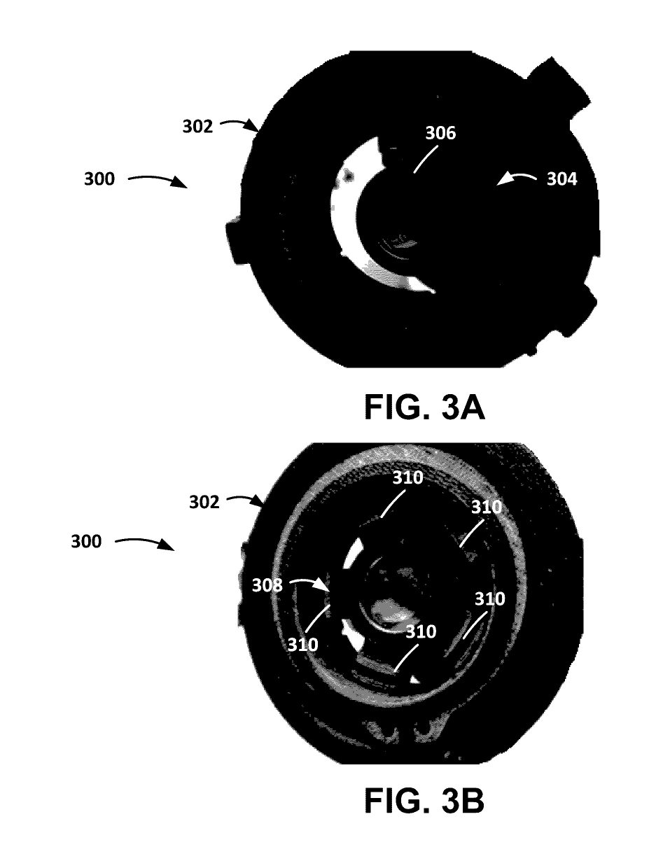

In embodiments, to attach the detector 110 and/or the computing device 112 to the ocular device 108, an adaptor 122 may be used. Aspects of an illustrative adaptor are described in IMAGE COLLECTION THROUGH A MICROSCOPE AND AN ADAPTOR FOR USE THEREWITH, U.S. patent application Ser. No. 14/836,683 to Shankar et al., the entirety of which is hereby incorporated by reference herein. Furthermore, aspects of illustrative adaptors are described in reference to FIGS. 3A-6 below.

After the first portion, the second portion and other portions of the sample 106 are imaged (collectively referred to herein as “imaged portions”), the computing device 112 and/or one or more other devices (e.g., the server 124, the user device 126 and/or the mobile device 128) may combine the magnified imaged portions together to create a combined magnified image. In embodiments, the combined magnified image may be a magnified image of the entire sample 106. In other embodiments, the combined magnified image may be a portion of the entire sample 106. More detail about combining the magnified imaged portions is provided in FIGS. 10-13 below.

As stated above, the magnified imaged portions may be transferred to a server 124, a user device 126 (e.g., a desktop computer or laptop), a mobile device 128 (e.g., a smartphone or tablet) and/or the like over a network 130 via a communication link 118. In embodiments, the magnified images of the portions may be sequentially uploaded to a server 124, user device 126 and/or mobile device 128 and the server 124, user device 126 and/or mobile device 128 may combine the magnified images. In addition or alternatively, the user device 126 and/or the mobile device 128 may be used to view the combined magnified image. Being able to transfer the combined magnified image to a server 124, a user device 126 and/or mobile device 128 may facilitate case sharing between pathologists and qualified health care professionals.

In addition to the magnified imaged portions being transferred to a server 124, a user device 126 and/or a mobile device 128, additional information about the slide and/or sample may be transferred to one or more other devices (e.g., a server 124, a user device 126 and/or a mobile device 128). In embodiments, additional information about the slide and/or sample may include slide measurements (as determined, e.g., by the embodiments described herein), identifying information about the sample, which may be listed on the slide, and/or calibration data about the microscope (e.g., a transformation function, as described in reference to FIGS. 7A-7C below).

The network 130 may be, or include, any number of different types of communication networks such as, for example, a bus network, a short messaging service (SMS), a local area network (LAN), a wireless LAN (WLAN), a wide area network (WAN), the Internet, Bluetooth, a P2P network, custom-designed communication or messaging protocols, and/or the like. The network 130 may include a combination of multiple networks.

FIG. 2 is a block diagram 200 of an illustrative computing device 205 for slide imaging, in accordance with embodiments of the disclosure. The computing device 205 may include any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “general-purpose graphics processing units (GPGPUs),” and the like, all of which are contemplated within the scope of FIGS. 1 and 2, with reference to various components of the system 100 and/or computing device 205. For example, the computing device 205 depicted in FIG. 2 may be, be similar to, include, or be included in, the computing device 112, the server 124, the user device 126 ad/or the mobile device 128, depicted in FIG. 1.

In embodiments, the computing device 205 includes a bus 210 that, directly and/or indirectly, couples the following devices: a processor 215, a memory 220, an input/output (I/O) port 225, an I/O component 230, and a power supply 235. The bus 210 represents what may be one or more busses (such as, for example, an address bus, data bus, or combination thereof). Similarly, in embodiments, the computing device 205 may include a number of processors 215, a number of memory components 220, a number of I/O ports 225, a number of I/O components 230, and/or a number of power supplies 235. Additionally any number of these components, or combinations thereof, may be distributed and/or duplicated across a number of computing devices.

In embodiments, the memory 220 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In embodiments, the memory 220 stores computer-executable instructions 240 for causing the processor 215 to implement aspects of embodiments of system components discussed herein and/or to perform aspects of embodiments of methods and procedures discussed herein.

The computer-executable instructions 240 may include, for example, computer code, machine-useable instructions, and the like such as, for example, program components capable of being executed by one or more processors 215 associated with the computing device 205. Program components may be programmed using any number of different programming environments, including various languages, development kits, frameworks, and/or the like. Some or all of the functionality contemplated herein may also, or alternatively, be implemented in hardware and/or firmware.

The I/O component 230 may include a presentation component configured to present information to a user such as, for example, a display device, a speaker, a printing device, and/or the like, and/or an input component such as, for example, a microphone, a joystick, a satellite dish, a scanner, a printer, a wireless device, a keyboard, a pen, a voice input device, a touch input device, a touch-screen device, an interactive display device, a mouse, and/or the like. In embodiments, the I/O component 230 may be a wireless or wired connection that is used to communicate with other components described herein. For example, the I/O component may be used to communicate with the computing device 112, the platform 114, the slide displacement mechanism 120, the server 124, the user device 126, and/or the mobile 128 depicted in FIG. 1. Furthermore, any number of additional components, different components, and/or combinations of components may also be included in the computing device 205.

In embodiments, the computing device 205 may also be coupled to, or include, a detector 245 for receiving light (e.g., the light projected through the first and second portions discussed above in relation to FIG. 1.) In embodiments, the detector 245 may have some or all of the same functionality as the detector 110 discussed above in relation to FIG. 1. In embodiments, the detector 245 may be incorporated into a digital camera 250. In embodiments, the digital camera 250 may have some or all of the same functionality as the digital camera discussed above in relation to FIG. 1.

The illustrative computing device 205 shown in FIG. 2 is not intended to suggest any limitation as to the scope of use or functionality of embodiments of the present disclosure. Neither should the illustrative computing device 205 be interpreted as having any dependency or requirement related to any single component or combination of components illustrated therein. Additionally, various components depicted in FIG. 2 may be, in embodiments, integrated with various ones of the other components depicted therein (and/or components not illustrated), all of which are considered to be within the ambit of the present disclosure.

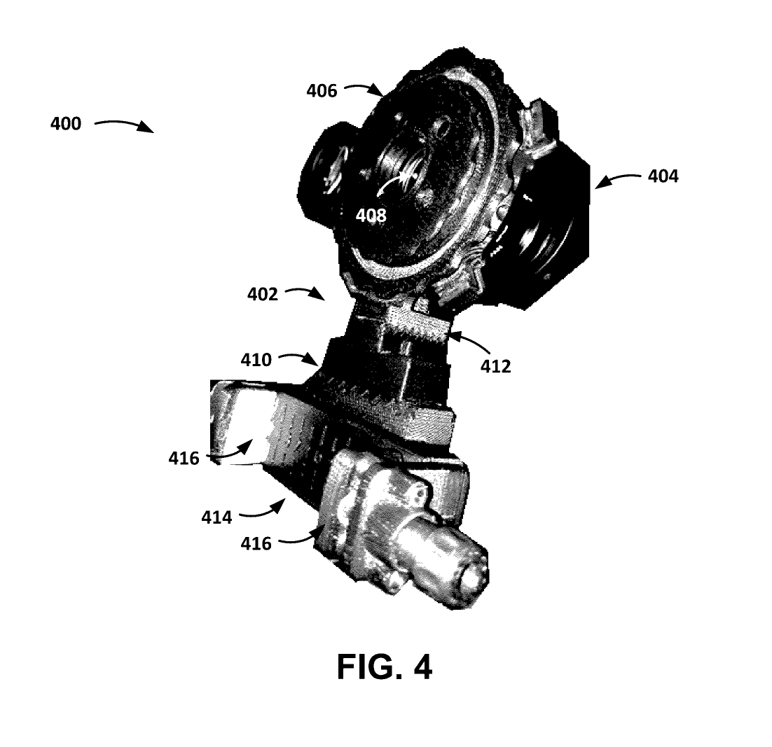

FIGS. 3A-3B are images of portions of an illustrative adaptor 300, in accordance with embodiments of the disclosure. The illustrative adaptor 300 discussed in FIGS. 3A-3B, as well as in FIGS. 4-6, is capable of attaching a computing device (e.g., the computing device 112 depicted in FIG. 1 and/or the computing device 205 depicted in FIG. 2) to an ocular device (e.g., the ocular device 108 depicted in FIG. 1).

As shown in FIG. 3A, the illustrated adapter 300 includes a housing 302 that surrounds an opening 304. The opening 304 is configured to receive a barrel 306 of an ocular device. In embodiments, the opening 304 may be a circular opening, as illustrated in FIGS. 3A-3B. In embodiments, the opening 304 may have a diameter of, for example, 3 cm, 4 cm, 5 cm, and/or the like. In other embodiments, the opening 304 may be other shapes.

The housing 302 of the adaptor 300 is configured to house an ocular clamp 308 (depicted in FIG. 3B). In embodiments, the ocular clamp 308 may include one or more extensions 310 that are capable of being retracted in a radial direction into the housing 302, as shown in FIG. 3A. In other embodiments, the extensions 310 may be capable of being retracted in a radial direction through the housing 302. Additionally, the extensions 310 of the ocular clamp 308 may be capable of extending from the housing 302 in a radial direction inwardly towards the center of the opening 304, as shown in FIG. 3B. In embodiments, the extensions 310 may protrude through the housing 302 in a radial direction inwardly towards the center.

The extensions 310 are used to couple the adaptor 300 to the barrel 306 of an ocular device. For example, the extensions 310 may resemble jaws that grip the barrel 306 of the ocular device. As another example, the extensions 310 may be screws that extend through the housing 302 into the opening 304. In embodiments, the barrel 306 may extend into the opening 304, for example, 0.25 cm, 0.5 cm, 0.75 cm, 1.0 cm and/or the like, so that the extensions 310 can adequately grip the barrel 306. In embodiments, the housing 302 may be rotated in a clockwise and/or counterclockwise direction to retract the extensions 310 into the housing and/or extend the extensions 310 from the housing 302. In other embodiments, a button (not shown) or other mechanism (e.g., a screwdriver) may be used to retract and/or extend the extensions 310. While extensions 310 are shown, other mechanism may be used to grip the barrel 306. For example, the housing 302 may include a mechanism that decreases the circumference of the housing 302 until the housing contacts and grips the barrel 306, similar to a pipe clamp.

FIG. 4 is an isometric view of an image 400 of an illustrative adaptor 402 coupled to an ocular device 404, in accordance with embodiments of the disclosure. Only a portion of the ocular device 404 is shown in the image 400, however, it is to be understood that the ocular device 404 may be similar to the ocular devices discussed above, for example, the ocular device 108 depicted in FIG. 1. In embodiments, the adaptor 402 may be coupled to the barrel of the ocular device 404, similar to how the adaptor 300 depicted in FIG. 3 couples to the barrel of an ocular device. For example, in embodiments, the adaptor 402 may include extensions (not shown in FIG. 4, but, e.g., the extensions 310 depicted in FIG. 3) that extend from or protrude through the housing 406 of the adaptor 402.

As shown, the adaptor 402 also includes an aperture 408. When a detector is coupled to the adaptor 402, the detector is positioned over the aperture 408 so that light passing through the ocular device 404, passes through the aperture 408 and is received by the detector (not shown). In embodiments, a horizontal adjustment mechanism 410 and a depth adjustment mechanism 412 may be used to position the detector over the aperture 408. In embodiments, the horizontal adjustment mechanism 410 and the depth adjustment mechanism 412 may be a course adjustment.

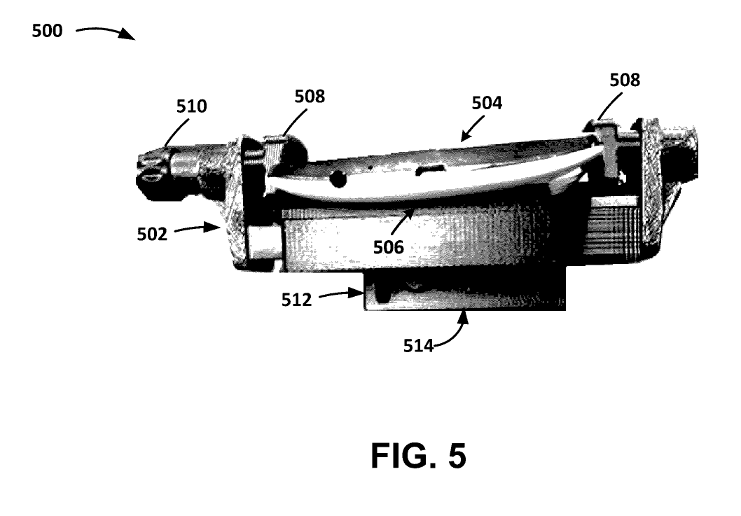

A detector and computing device are not coupled to the adaptor 402 in the illustrated embodiment. However, in embodiments, a detector and/or computing device may be coupled the adaptor 402 before the adaptor 402 is coupled to the ocular device 404. In embodiments, the adaptor 402 includes a platform 414 and a coupling mechanism 416 to secure a detector and/or computing device to the adaptor 402. In embodiments, the coupling mechanism 416 may be also be configured to position the detector over the aperture 408, as explained in more detail in FIG. 5 below. In embodiments, the coupling mechanism 416 may complement the course adjustment of the horizontal and depth adjustment mechanisms 410, 412, by providing a fine adjustment.

FIG. 5 is a top view of an image 500 of an illustrative adaptor 502 coupled to a computing device 504, in accordance with embodiments of the disclosure. In the embodiment shown, the detector is incorporated into the computing device 504. During the discussion of FIG. 5, reference will be made to coupling a computing device 504 to the adaptor 502, but it is to be understood that, in embodiments, only a detector may be coupled to the adaptor 502.

To secure a computing device 504 to the adaptor 502, the computing device 504 may be placed on a platform 506 of the adaptor 502. In embodiments, the computing device 504 may be a smartphone and/or tablet. As such, in embodiments, the platform 506 may have a width capable of receiving smart phones (e.g., an iPhone, a Samsung Galaxy, etc.). For example, the platform 506 may have a width of 4 cm, 5 cm, 6 cm, 7 cm, 8 cm, 9 cm, and/or the like. In embodiments, the width of the platform 506 may be larger so that the platform 506 may be able to accommodate a tablet (e.g., an iPad, Samsung Galaxy Tab, etc.). For example, the platform 506 may have a width of 14 cm, 15 cm, 16 cm, 17 cm, 18 cm, 19 cm, and/or the like.

To couple the computing device 504 to the adaptor 502, the computing device 504 may be placed on the platform 506, with the detector included in the computing device 504 facing towards platform. In embodiments, the adaptor 502 may include a coupling mechanism 508 that is capable of extending inward, toward the computing device 504. The coupling mechanism 508 is capable of extending inward until it engages the sides of the computing device 504. In embodiments, the coupling mechanism 508 may resemble a vice, so that when an actuating mechanism 510 is actuated in a first direction (e.g., clockwise), the coupling mechanism 508 extends inward, towards the computing device 504. Conversely, when the actuating mechanism 510 is actuated in a second direction (e.g., counterclockwise), the coupling mechanism 508 retracts, away from the computing device 504. While only one actuating mechanism 510 is depicted in FIG. 5, in other embodiments, a separate actuating mechanism 510 may be used for each portion of the coupling mechanism 508. Alternatively or additionally, the coupling mechanism 508 may be spring loaded, so that the springs provide a force on the each side of the coupling mechanism 508 in the direction of the computing device 504. As such, the coupling mechanism 508 may grip the sides of the computing device 504 when a computing device 504 is loaded on to the platform 506.

As shown, the adaptor 502 includes a housing 512 that is configured to received a barrel of an ocular device. The housing 512 may be used to couple the adaptor 502 onto the barrel of an ocular device, similar to how the housings, 302, 406, depicted in FIGS. 3A-3B and FIG. 4, respectively, is coupled to the barrel of an ocular device. Additionally, the housing 512 also includes an aperature 514 (e.g., the opening 304 depicted in FIG. 3 and/or the aperture 408 depicted in FIG. 4) so that light projecting through an ocular device can be project through the aperture 514 in the housing 512 and be received by the detector included in the computing device 504.

In addition to gripping the computing device 504, the coupling mechanism 508 may be adjusted either in conjunction or independently to facilitate aligning the detector included in the computing device 504 with the aperture 514, so that any light that projects through the aperture 514 can be detected by the detector included in the computing device 504. In embodiments, these adjustments may provide a fine adjustment to the horizontal and depth adjustment mechanisms 410, 412 depicted in FIG. 4. In embodiments, the positioning of the detector included in the computing device 504 may be facilitated by an application running on the computing device 504. In embodiments, the computing device 504 may determine any aberrancy in illumination to facilitate positioning of the detector over the aperture 514. For example, the computing device 504 may provide instructions to a user whether to actuate the actuating mechanism 510 in a clockwise and/or counterclockwise direction so that the detector incorporated into the computing device 504 is appropriately positioned over the aperture 514. In embodiments, the computing device 504 may also instruct a user how to adjust any course adjustment mechanisms (e.g., the horizontal and depth adjustment mechanisms 410, 412 depicted in FIG. 4) the computing device 504.

Once the detector and/or computing device 504 is coupled to the adaptor 502 and the adaptor is coupled to an ocular device, the computing device 504 may be determine any displacement of the computing device 504 using a gyroscope incorporated into the computing device 504 when the detector is detecting magnified images. In embodiments, the computing device 504 may either compensate for the displacement or instruct a user to reposition the computing device 504 to the computing device's 504 original position. This may facilitate higher quality combined magnified images.

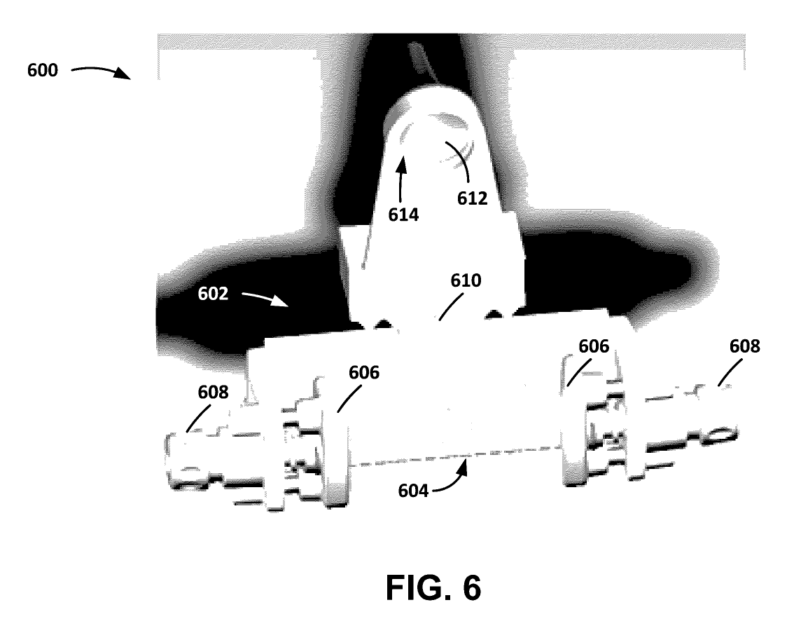

FIG. 6 is an image 600 of another illustrative adaptor 602, in accordance with embodiments of the disclosure. The illustrative adaptor 602 includes a platform 604 for supporting a detector and/or computing device, a coupling mechanism 606 for coupling a detector and/or computing device to the adaptor 602 and actuating mechanisms 608 for actuating the coupling mechanism 606, similar to the actuating mechanism 510 depicted in FIG. 5. The illustrative adaptor 602 also includes a horizontal adjustment mechanism 610, similar to the horizontal adjustment mechanism 410 depicted in FIG. 4. In embodiments, the coupling mechanism 606 and horizontal adjustment mechanism 610 may facilitate positioning a detector over an aperture 614 included in the adaptor 602. Contrary to the adaptor 502 depicted in FIG. 5, the adaptor 602 may not be coupled to a separate ocular device, but may instead itself be an ocular device and include an objective lens 612 in the aperture 614 for magnifying a sample. In embodiments, the sample may be a person's eye, inner ear, mouth, throat, and/or other orifice.

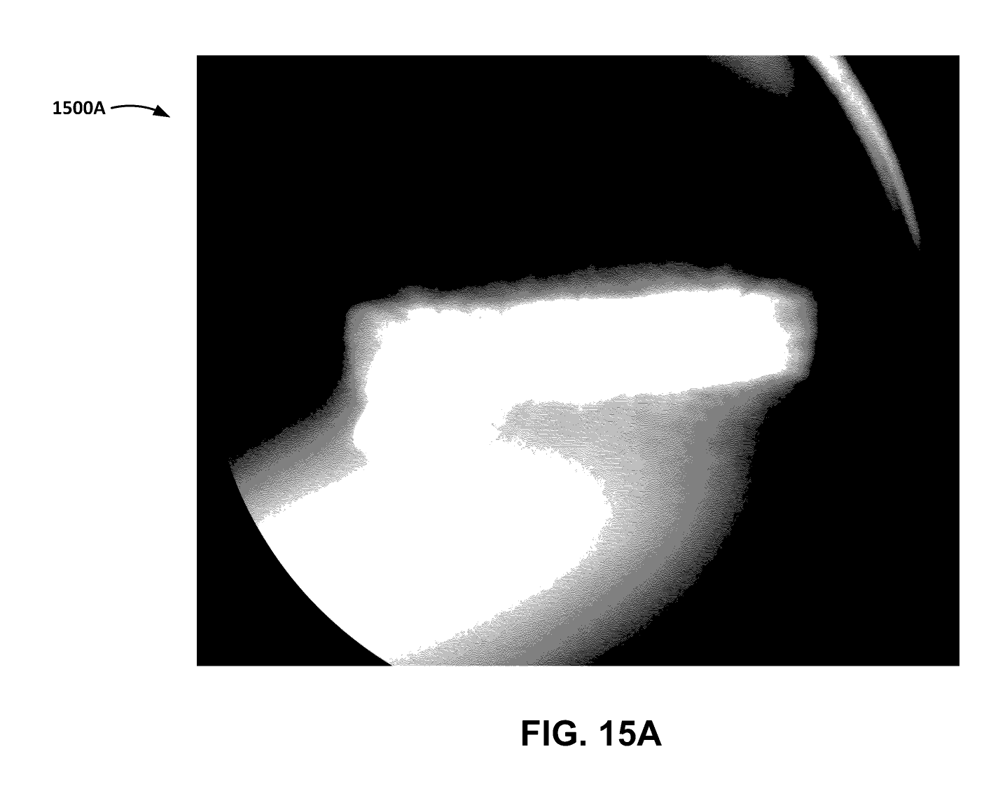

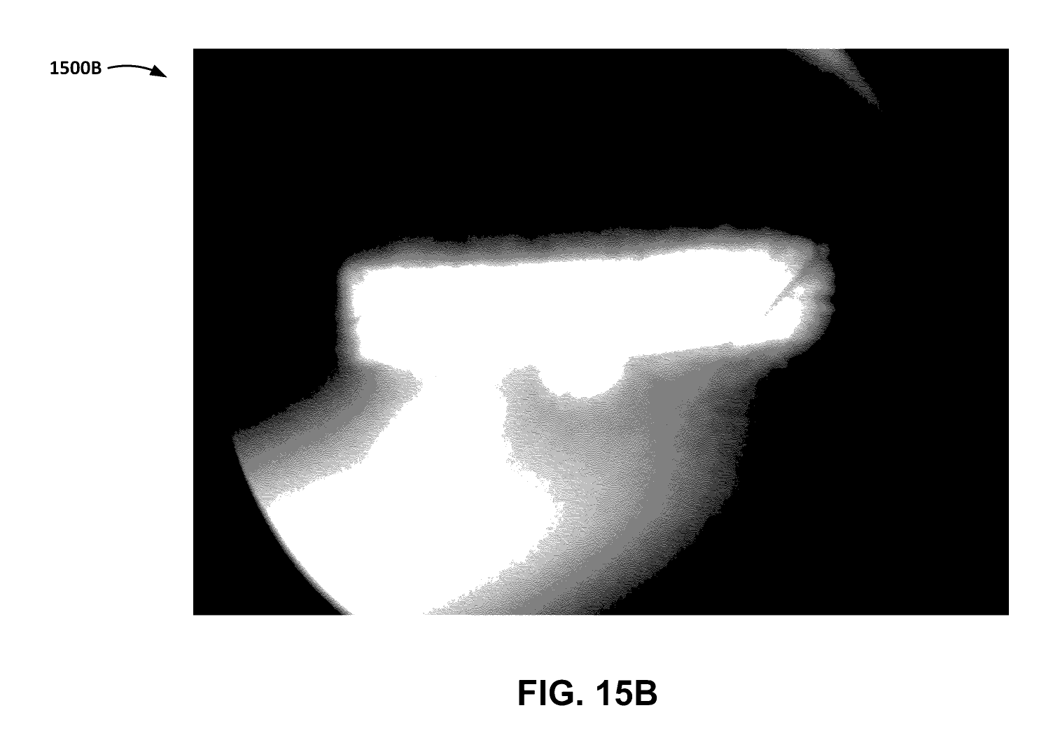

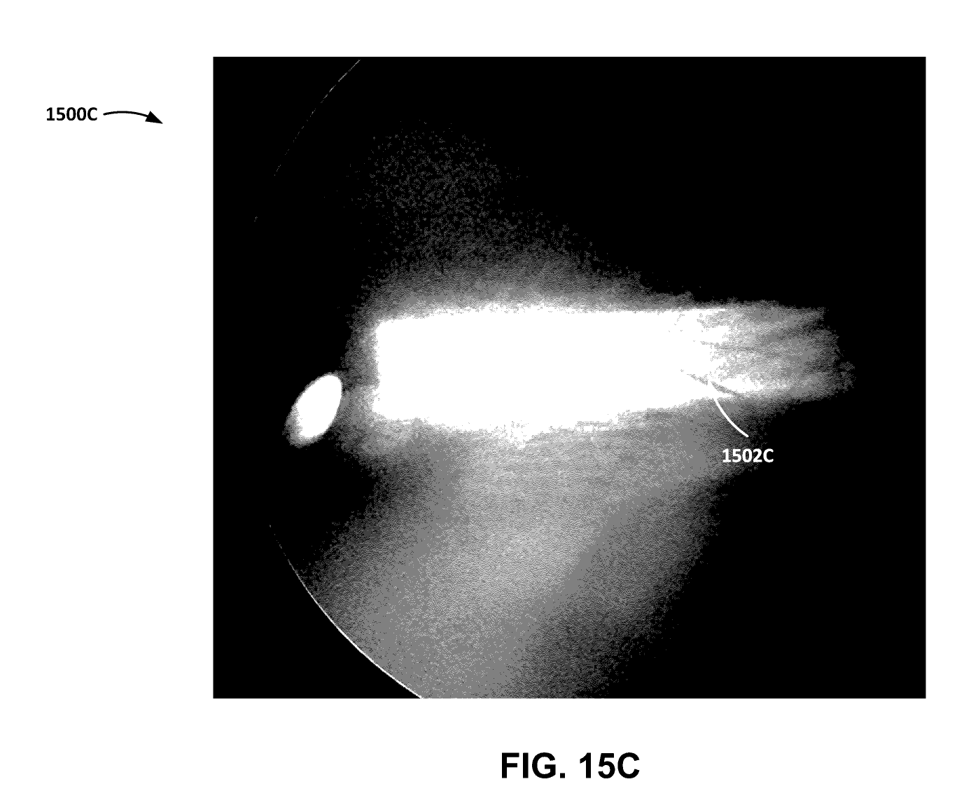

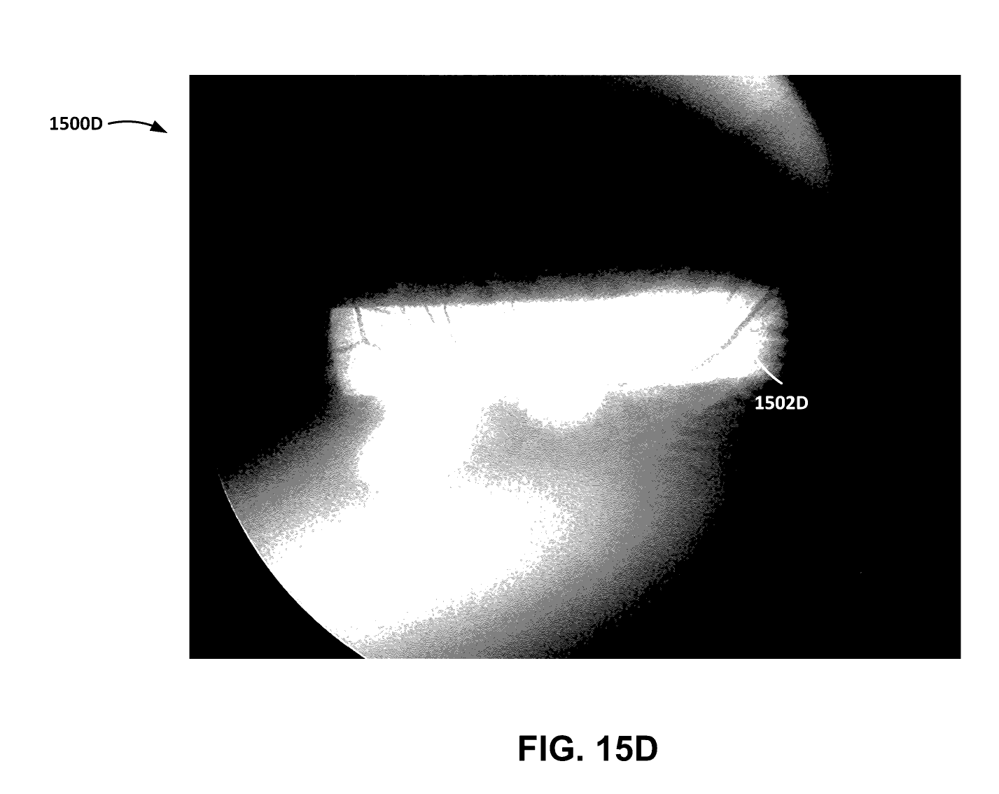

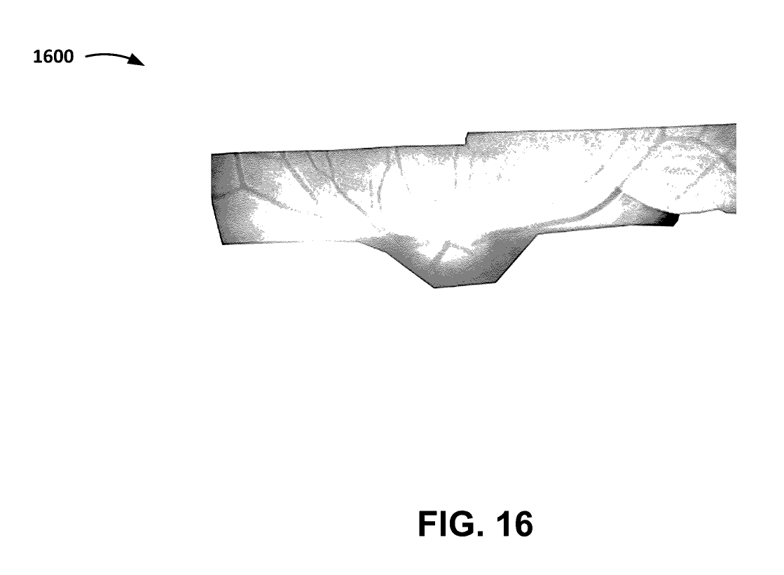

To image a sample (e.g., a person's eye, inner ear, mouth, throat and/or other orifice) using the adaptor 602, a computing device and/or detector, that is coupled to the adaptor 602, may be set to a “burst mode.” In embodiments, a burst mode may capture a plurality of images of one or more portions of a sample. Some of these images may be in focus and others may be out of focus. In embodiments, the computing device may determine which images are in focus (e.g., using the embodiments described above in relation to FIG. 1) and, after which, may combine the images together using, for example, the embodiments described in reference to FIGS. 7A-17 below. Examples of images of a person's eye that were taken in “burst mode” are depicted in FIGS. 15A-15D and a combined image is depicted in FIG. 16.

FIGS. 7A-7C are images 700A-700C of illustrative calibration grids 702A-702C, in accordance with embodiments of the disclosure. The calibration grids 702A-702C are used to determine an amount of distortion caused by one or more lenses of an ocular device.

Referring to FIG. 7A, a calibration grid 702A is depicted, as the calibration grid 702A is perceived through a lens of the ocular device (e.g., the ocular device 108 depicted in FIG. 1). In embodiments, the calibration grid 702A includes lines 704 which are used to facilitate determining an amount of distortion caused by the curvature of the lens. For example, the length and/or curvature of the lines 704 are known and, when the calibration grid is placed under the lens of the ocular device, the length and/or curvature of the lines 704, as perceived through the lens of the ocular device, may have a different length and/or curvature. A transformation function is determined that transforms the perceived length and/or curvature of the lines 704 back to the known length and/or curvature of the lines 704. The determined transformation function may be determined to undistort other images that are perceived through the lens of the ocular device.

In the example depicted in FIG. 7A, the calibration grid 702A may be placed on the platform (e.g., the platform 114 depicted in FIG. 1) of an ocular device; or, alternatively, the calibration grid 702A may be incorporated into the platform of an ocular device. In embodiments, at least some of the lines 704 of the calibration grid 702A extend from a center portion of the field of view 706 to approximately an edge portion of the field of view 706. The field of view 706 is due to the lens of the ocular device being circular and the detector being rectangular. That is, the image 700A includes portions that are outside the field of view 706 of the lens of the ocular device. The curvature of the lens near the center of the lens may be different than the curvature of the lens near the periphery of the lens. In embodiments, a center portion of the field of view 706 may be approximately +/−15%*the radius of the field of view 706 away from the center of the field of view 706. In embodiments, an edge portion of the field of view 706 may be approximately +/−15%*the radius of the field of view 706 away from the edge of the field of view 706. As such, having at least some of the lines 704 extend from a center portion of the image 700A to approximately an edge portion of the field of view 706 of the image 700A may facilitate in determining the curvature differences of different portions of the lens. In embodiments, each portion of the lens may have a respective transformation function that is used to undistort each of these portions.

After the calibration grid 702A is viewable through the lens of an ocular device, the platform of the ocular device may be raised and/or lowered so that the lines 704 of the calibration grid 702A are in focus. In embodiments, the lines 704 may be in focus when they have distinct edges and/or using the embodiments described above in reference to FIG. 1. In embodiments, after the lines 704 are in focus, the z-position of the platform may be stored in memory. In embodiments, the distortion of the lens may be correlated to the position of the platform and the field of view 706. For any changes to the position of the platform (e.g., to focus an image), the transformation function may be adjusted based on the changed field of view 706 size brought about by altering the position of the platform.

After the lines 704 are in focus, a computing device (e.g., the computing device 112 depicted in FIG. 1 or the computing device 205 depicted in FIG. 2) may use an edge detection algorithm (e.g., Harris Corner Detection) to determine the presence of one or more points on the lines 704. For example, the three points 708A-708C on the outer most line 704 of the calibration grid 702A may be detected. After which, the computing device may determine whether the one or more detected points 708A-708C are linked together by, for example, determining whether there are additionally points, between the one or more detected points 708A-708C, that link the one or more detected points 708A-708C. In embodiments, Deming Regression may also be used to determine whether the points 708A-708C are part of the same line 704. In embodiments, if the one or more detected points 708A-708C are less than a threshold distance apart (e.g., 5 pixels, 10 pixels, 15 pixels, 20 pixels, 25 pixels, and/or the like), the one or more detected points 708A-708C may be discarded and the process may repeated by the computing device to detect other points that are on the lines 704. If, however, the one or more detected points 708A-708C are greater than a threshold length, the computing device may determine the presence of a line 704. In embodiments, however, if a line is too long (e.g., greater than 75 pixels), it may be disregarded, as well, since a line that is too long may be difficult to fit to an arc.

After determining the presence of a line 704, the perceived curvature and/or length of the line 704 may be determined. To determine the perceived curvature and/or length of the line 704, three or more points on a line 704 may be identified, for example, the three detected points 708A-708C. After identifying the three or more points 708A-708C, the three or more points 708A-708C may be determined to be either collinear or not collinear (e.g., using Deming Regression) and/or using the methods described above for determining the presence of a line 704. Additionally, in embodiments, and similar to determining the presence of a line 704, the three or more points 708A-708C on a line 704 may be selected so that they are threshold distance apart from one another. When the three or more points 708A-708C are a threshold distance from one another, the computing device may be able to more accurately determine whether the three or more points 708A-708C are either collinear or not collinear. After which, the three or more points 708A-708C may be fitted to an arc (e.g., a circle). Once the equation for the arc is determined, a transformation function may be determined that transforms the arc into an undistorted line (e.g., Iterative using Nonlinear Optimization techniques) by comparing the equation for the arc against the known curvature and length of the line 704. That is, a transformation function may be determined that transforms the equation of the arc, that is fit to the line 704, to the known equation of the line 704. In embodiments, this process may be repeated for other lines 704 included in the calibration grid 704A. Each of the transformation functions may be correlated to respective portions of the field of view 706. For example, the portion of an image near an edge of the field of view 706 may be correlated to a respective transformation function, the portion of an image near the center of the field of view 706 may be correlated to a respective transformation function and/or portions of the image therebetween may be corrected to one or more respective transformation functions. After which, parts of a magnified image that are received in the respective portions of the field of view 706 may be transformed (i.e., undistorted) according to the transformation functions that are correlated to the respective portions. Additionally or alternatively, the one or more transformation functions may be combined to determine a transformation function that transforms the distorted image into an undistorted image and/or the combined transformation function may be used to undistort different portions of an image (e.g., the portion of an image near an edge of the field of view 706, the portion of an image near the center of the field of view 706 and/or portions of the image therebetween).

In ocular devices that include more than one objective lens (e.g., a 4 objective binocular microscope), one or more transformation functions may be computed for each of the objective lens.

Additionally, in embodiments, after the lines 704 are in focus, e.g., by adjusting the position of the platform (i.e., the z-position of the platform, as depicted in the coordinate system 116 of FIG. 1), the dimensions of the field of view 706 may be determined using the known lengths of the lines 704.

In embodiments, a computing device may also receive the principal point offset (i.e., the center of the image in pixels) and scale. That is, the optical axis may correspond to the image center; however, the image center may be placed in a different location than the optical axis, which is determined by the principal point offset. The scale may be used for rendering to allow for scaling of the combined image. In embodiments, a computing device may also receive the focal length (i.e., the distance from the detector to the focal point) in, e.g., pixels, inches and/or millimeters (mm). The focal length may be provided by the lens manufacture of the detector, stored in metadata of the detector and received by a computing device. For detectors including zoom lenses, the focal length may vary, which can be received by computing device. A computing device may also receive the field-of-view type (e.g., diagonal, horizontal or vertical) and field-of-view value (e.g., the field-of-view angle (in radians or degrees)). The field-of-view may be expressed as an angle of view, i.e., angular range captured by the sensor, measured in different directions (e.g., diagonal, horizontal or vertical). A computing device may also determine a lens distortion and a kappa value (e.g., kappa>0 implies a pincushion distortion and kappa<0 implies barrel distortion). That is, lenses are not perfectly spherical and manifest various geometric distortions. In embodiments, the computing device may model the distortion of a lens using radial polynomials. That is, for example, the computing device may determine one or more distances from the center of an image to one or more pixels/points and compare the distances to the original distances from the center of the calibration grid to the pixels/points on the calibration grid. In embodiments, the lens distortion may be quantified using one or two parameters. In embodiments, the computing device may also determine the projection type (e.g., planar). That is, the projection type is an indication of the surface on which the image is projected. In embodiments, a planar projection may be the default projection. In embodiments, the computing device may also determine the detector's sensor size (e.g., width and height in pixels, inches and/or mm). In embodiments, the sensor size and the focal length may be used to determine the field of view. Alternatively, the sensor size and field of view may be used to determine the focal length. Each of the above parameters may be used when combining the images. That is, for example, the above parameters may be determined for a first magnified imaged portion and for each subsequent magnified imaged portion of a sample. After which, the parameters for each subsequent magnified image portion may be used to adjust and/or conform each subsequent magnified image portion to the parameters of the first magnified image portion. In embodiments, the above parameters, along with the position of the platform may be stored in memory.

FIG. 7B is an image 700B of another illustrative calibration grid 702B, in accordance with embodiments of the disclosure. The calibration grid 702B depicted in FIG. 7B was created using the display of a smartphone and, similar to the example depicted in FIG. 7A, the smartphone that includes the calibration 702B may be placed on the platform (e.g., the platform 114 depicted in FIG. 1) of an ocular device. That is, the display of a smartphone includes a plurality of pixels that emit light. That is, the pixels are depicted as dots within the field of view 706. In the embodiments shown in FIGS. 7B, 7C, the colors have been inverted, so the portions outside of the edge of the field of view 706 is shown as white, the pixels are shown as black and the spaces between the pixels are white. In embodiments, however, the pixels may be white, the spaces between the pixels may be black and the portions outside of the edge of the field of view 706 may be black (as the field of view 706 is depicted in FIG. 7A). In embodiments, one or more rows of pixels and/or a line that is created by the absence of a row of pixels may be used as the lines in the calibration grid 702B. Using the embodiments described above in relation to FIG. 7A, a transformation function may be determined using the calibration grid 702B in order to correct for any distortion caused by the lens of the ocular device. An image 700C of the calibration grid 702B after the calibration grid 702B has been undistorted is depicted in FIG. 7C.

The pixels displayed in FIG. 7B are magnified 4x and the display used to produce the depicted image 700B is an AMOLED capacitive touchscreen that is capable of producing 16 million colors and has a screen size of 6″ with a resolution of 1440×2560 pixels (˜490 ppi pixel density). This is only an example, however, and not meant to be limiting. For example, other displays incorporated into smartphones may be used, as well. Also, in embodiments, while the embodiment shown is in black in white, the calibration grid 702B displayed by a display device may be color.

Additionally, in embodiments, a luminosity parameter may be generated during the calibration embodiments described above. In embodiments, too bright of a light beam (e.g., the light 104 emitted by the light source 102 depicted in FIG. 1) may flood the sensor with too many photons, possibly resulting in inadequate dynamic range of illumination. Appropriate light intensity may, therefore, be characterized by maximal and minimal cutoff points for beam intensity of a light source (e.g., the light source 102 depicted in FIG. 1). In embodiments, photons per unit pixel size of a sensor may be used to determine an appropriate beam intensity. In embodiments, the photons per unit pixel size of the sensor unit, along with the sensor's bit depth may be used to determine the highest ISO setting with the most appreciable signal to noise ratio. In embodiments, the ISO setting may be limited by the detector and/or computing device if the detector is incorporated into the computing device. For example, with the calibration grid in view (e.g., the calibration grid 702A or the calibration grid 702B), the computing device and/or the user may completely open the base and field diaphragms. The computing device and/or user may then either increase or decrease the beam intensity of the light source until an adequate brightness of field is attained. This data can then be used to determine the luminosity parameter. After a slide is placed on the platform (e.g., the platform 114 depicted in FIG. 1), the computing device and/or user may be given a final brightness prompt to either increase or decrease beam intensity to an appropriate level so that a similar luminosity as the luminosity parameter is obtained. At this point, the luminosity may be standardized and imaging a portion of the sample may commence.

In embodiments, the calibration process described above may be performed once when a new ocular device is being used to image a sample. After which, a lens profile may be generated and stored in memory (e.g., memory included in a computing device 112, server 124, user device 126 and/or mobile device 128 depicted in FIG. 1). When the computing device identifies (e.g., using a Radio Frequency Identification (RFID) chip, a Quick Response (QR) code, a Near-Field Communication (NFC) and/or the like) an ocular device and/or the ocular device is identified by a user (e.g., by a identifier, such as a sticker, applied to the ocular device) and specified to the computing device, the computing device may retrieve the transformation function and apply the transformation function to any sample (or portion of a sample) imaged using the ocular device. In embodiments, if the curvature of the lens of an ocular device cannot be determined accurately, the computing device may apply a visual indicator (e.g., watermark) on any image produced using the computing device.

In addition or alternatively, the calibration process described above may be performed every time a new sample is being imaged and/or every time a portion of a sample is being imaged.

As discussed above, a scouting image of a sample may be taken. FIG. 8 depicts an illustrative scouting image 800, in accordance with embodiments of the disclosure. In embodiments, the scouting image 800 may include representations of features, of a sample 802, that are lower resolution than the representations of the features included in the first portion, second portion, etc. discussed above in relation to FIG. 1. That is, the scouting image 800 may be an image of an entire sample 802, which includes all the features of the sample 802, and have a resolution of, for example, 200 pixels per inch (ppi). On the contrary, the first portion, second portion, etc. only include a subset of all of the features of the sample 802, and may have a similar resolution of 200 ppi. As such, a feature included in the scouting image 800 may be represented by 4 pixels, whereas the same feature represented in a first portion may be represented by, e.g., 64 pixels. While 200 ppi is described as an example, the scouting image 800 and the first portion, second portion, etc. may have other resolutions (e.g., 100 ppi, 300 ppi, 400 ppi and/or the like).

In embodiments, the pixels included in the scouting image 800 may be mapped to a set of coordinates. Using the coordinate map, the positions of features included in the scouting image 800 may be identified. After which, when the first and second portions are imaged, if the first and second portions include one or more of the features identified in the scouting image 800, then the location of the first and second portions within the larger sample 802 can be determined. Using this technique, a computing device can determine whether the entire sample 802 has been imaged and/or whether a desired sub-portion of the sample has been completely imaged. In addition to determining whether the desired portion has been imaged, the set of coordinates may be used by a computing device to instruct how a slide displacement mechanism (e.g., the slide displacement mechanism 120 depicted in FIG. 1) should displace the slide including the sample 802 for the next portion to be imaged.

In addition to determining what portion of the sample 802 is being imaged, the scouting image 800 may be used to correct some defects in an image. For example, light related shadow aberrancies may be present in an image. In embodiments, the shadow aberrancies may incorrectly be determined to be features. As such, in embodiments, a second light source may be positioned so that the light emitted from the second light source generates shadows larger than the shadows produced by the tissue of the sample 802. For example, two scouting images of the sample 802 are taken. The first scouting image may be taken when the second light source is positioned on a first side of the sample 802 and the second scouting image may be taken where the second light source is positioned on a second side of the sample 802, where the second side is on the opposing side of the sample 802 as the first side. Using the two scouting images, any shadow aberrancies of the sample 802 that may be present may be reduced by comparing the images and masking the shadows (e.g., eliminating portions that are present in one scouting image, but not both scouting images). Using this technique, any shadow aberrancies may be reduced so that they are not incorrectly identified as features.

FIGS. 9A-9B are images 900A, 900B of an illustrative sample 902 as the sample 902 is perceived through a lens of the ocular device, in accordance with embodiments of the disclosure. Referring to FIG. 9A, after a detector (e.g., the detector 110 depicted in FIG. 1 or the detector 245 in FIG. 2) is attached using, e.g., an adaptor (e.g., the adaptors depicted in FIGS. 1, 3A-6) to a barrel of the ocular device (e.g., the ocular device 108 depicted in FIG. 1), an image 900A including a sample 902 and a circular mask 904 (i.e., the black portion) may be detected. The circular mask 904 is due to the lens of the ocular device being circular and the detector being rectangular. That is, the image 900A includes portions that are outside the field of view 908 of the lens of the ocular device.

When the detector is coupled to a computing device (e.g., the computing device 112 depicted in FIG. 1 or the computing device 205 depicted in FIG. 2) and the computing device receives the image 900A detected by the detector, the computing device may instruct a platform (e.g., the platform 114 depicted in FIG. 1) to raise and/or lower, so that the detected image 900A becomes in focus. An in-focus image 900B is depicted in FIG. 9B. In embodiments, the computing device may instruct the platform to be raised and/or lowered until the detector detects a clear image, distinct features 906B in the image 900B and a solid black outline, as shown in FIG. 9B. As shown in FIG. 9B, features 906B in the sample 902 are clearly defined, whereas the features 906A shown in FIG. 9A are not clearly defined. In embodiments, a clear image may be detected when Kohler Illumination is present. Kohler Illumination may be determined to be present when a characteristics blue hue is present at the edges of a sharply defined edge of the field of view 908. Additionally or alternatively, the platform may be raised and/or lowered manually until the image 900A comes into focus as described in relation to FIG. 1 above.

In embodiments, after the image 900A, 900B is focused, the computing device may determine the luminosity of the detected image 900A, 900B. The determined luminosity may be used to change the detector's characteristics (e.g., the ISO, shutter speed and/or white balance) and/or the light emitted from a light source (e.g., the light source 102 depicted in FIG. 1) of the ocular device, so that when other portions of the sample are being detected, each portion may be configured to have approximately the same luminosity level. In some embodiments, if the luminosity is outside a range so that the luminosity cannot be changed to approximately the same luminosity level of other imaged portions using the ISO, shutter speed and/or white balance of the detector, then the light emitted from a light source may be changed. In embodiments, the same luminosity for each portion may be conformed to one another so that the combined image may be of higher quality.

In embodiments, after a first portion of the sample 902 is detected and imaged, the computing device may instruct a slide displacement mechanism (e.g., the slide displacement mechanism 120 depicted in FIG. 1) to shift the sample. After the sample is shifted so that a second portion (or third portion, fourth portion, etc.) is detected by the detector, the computing device may instruct the platform to be raised and/or lowered so that the second portion (or third portion, fourth portion, etc.) is in focus.

After a portion of a sample is in focus using, for example the focusing techniques described in FIGS. 9A-9B, an image of the portion is taken. The image of the portion is analyzed by a computing device (e.g., the computing device 112 depicted in FIG. 1 or the computing device 205 depicted in FIG. 2) to determine a circular mask and features included in the image. FIG. 10 is an image 1000 of an illustrative sample 1002 that includes a circular mask 1004 and set of detected features 1006, in accordance with embodiments of the disclosure.

As stated above, the circular mask 1004 (i.e., the black portion) is due to the circular shaped barrel and lens used in the ocular device and the detector being rectangular. A circular mask 1004 may be identified using corner detection (e.g., Harris Corner Detection) and/or by searching for contrasts in the image 1000. A contrast between two or more pixels in the image 1000 that is above a threshold may be indicative of a circular mask 1004. For example, in embodiments, the computing device may determine a first pixel of two or more adjacent pixels to be darker than a second pixel of the two or more adjacent pixels and that the contrast between the two levels of darkness of the first and second pixels is above a threshold. As such, the first pixel may be determined to be included in the circular mask 1004.

In embodiments, this procedure may be performed again, using a different set of adjacent pixels, to determine another pixel that is on the edge of the circular mask 1004. In embodiments, this process may be iteratively performed until all the pixels that are included in the edge of the circular mask 1004 are identified. In addition or alternatively, once one pixel is identified to be a part of the circular mask 1004, a radius of the circular mask 1004 may be used to determine all pixels that are included in the circular mask 1004. After identifying the circular mask 1004, the circular mask 1004 may be filtered out of the image 1000.

In addition to identifying a circular mask 1004, one or more features included in the image 1000 may be identified. For example, in embodiments, features 1006 may be identified in the image 1000. As illustrated in FIG. 10, only a portion of the features 1006 include an arrow directed at them, however, it is to be understood that each portion encompassed by a circle is an identified feature. In embodiments, the image 1000 may be subsampled to obtain features 1006 at different scales. In embodiments, a Multi-Scale Harris Corner Detection algorithm may be used to determine point features 1006 in the image 1000. For example, each feature 1006 may be correlated to a unique vector of numbers, i.e., descriptors. The descriptors are computed from pixel neighborhoods of each feature. In embodiments, the descriptors may be wavelet-based descriptors. In embodiments, the pixel neighborhoods may be normalized for brightness to facilitate the features 1006 for matching, as described herein.

In embodiments, since the number of features 1006 in an image 1000 may be large, only a subset of the identified features may be preserved. To determine a subset of identified features, an Adaptive Non-Maximal Suppression algorithm may be used. In embodiments, the subset of identified features may also be determined based on their spatial distribution to ensure features in different portions of the image 1000 are retained. In embodiments, features located near the circular mask 1004 may also be removed from the subset.

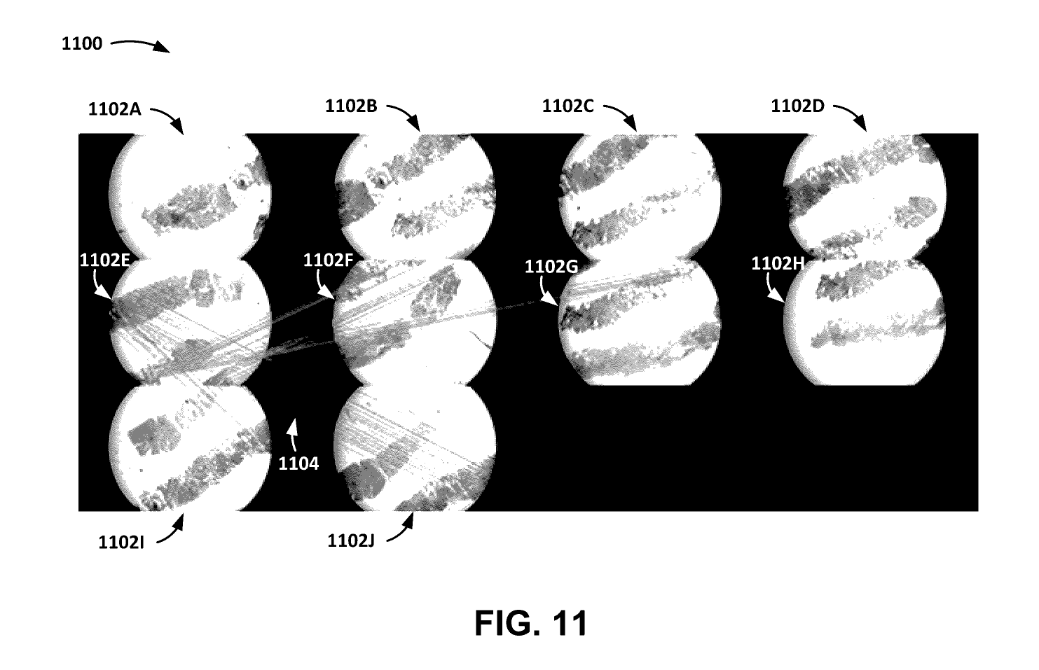

After features are identified in two or more magnified images, the two or more magnified images are combined. To facilitate combining two or more magnified images, a Mosaic Recognition algorithm, a Pathfinding algorithm, a Mosaic Optimization algorithm and/or a Color Mismatch Reduction algorithm may be used, as discussed in FIGS. 11-13 below.

FIG. 11 is an image 1100 of different imaged portions 1102A-1102J of a sample that includes detected features in each imaged portion 1102A-1102J, in accordance with embodiments of the disclosure. After one or more features are identified in the imaged portions 1102A-1102J, a determination may be made as to whether one or more features of the identified features are in other imaged portions 1102A-1102J. By determining whether one or more identified features are in the other imaged portions 1102A-1102J, a computing device can determine whether any of the imaged portions 1102A-1102J overlap.

To determine whether a feature is in more than one imaged portion 1102A-1102J, a Mosaic Recognition algorithm may be used on the imaged portions 1102A-1102J. That is, in embodiments, features from the subset of identified features (e.g., the subset of features described above in FIG. 10) of a first imaged portion (e.g., image portion 1102E) of the imaged portions 1102A-1102J, are compared and possibly matched to features included in other imaged portions (e.g., imaged portions 1102F, 1102G, 11021, 1102J) of the imaged portions 1102A-1102J. In embodiments, only a subset of the matched features may be retained. In embodiments, a k-dimensional tree and/or Best bin first algorithm may be used to search and match the identified features. When searching and matching identified features, the distance between the identified features (e.g., to determine the similarity of the identified features in different imaged portions 1102A-1102J) may be determined using the L2 distance of their descriptors (described above in relation to FIG. 10). Since the search may operate in a high-dimensional space (e.g., in 64 dimensions), an approximate search may be used.

In embodiments, there may be false matches. As such, a Feature Space Outlier Rejection algorithm may be used to remove many (e.g., 90-100% of the false matches). In embodiments, candidate images with the most correspondences 1104 (i.e., lines) for each imaged portion 1102A-1102J may be used to determine a set of potential imaged portion 1102A-1102J pairs. In embodiments, random sample consensus (RANSAC) filtering may be applied on each image pair to discard outliers, e.g., false correspondences not compliant to the hypothesis (model parameters) found so far.

In embodiments, after the filtering of false matches, a nonlinear refinement and guided matching may be used. These steps may be applied repeatedly to increase the number of actual correspondences (e.g., by eliminating false matches) and refine model parameters (including lens parameters) until the number of correspondences converges. Once the model parameters are found, a Bayesian statistical check may be performed to find whether the match is reliable enough. A match may be reliable enough if the number of filtered correspondences is large enough compared to all correspondences in the overlap area. In embodiments, some pairs are rejected this way and only correct ones may remain (i.e., imaged portions 1102A-1102J that are actually overlapping). The result is each image being connected to a number of other images (e.g., 0-10 other images).

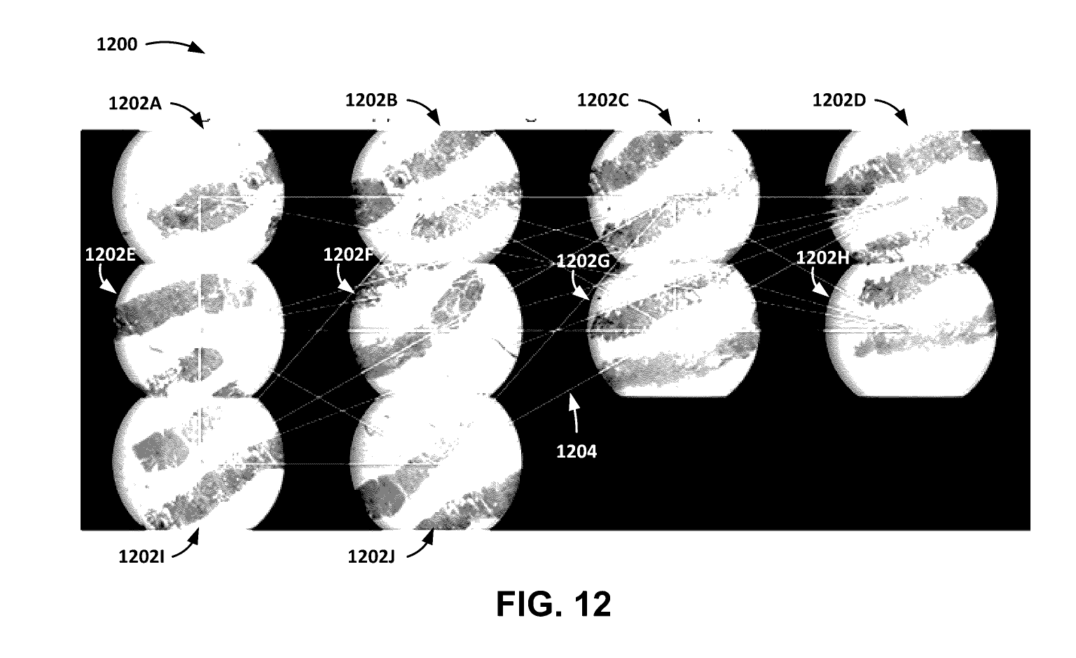

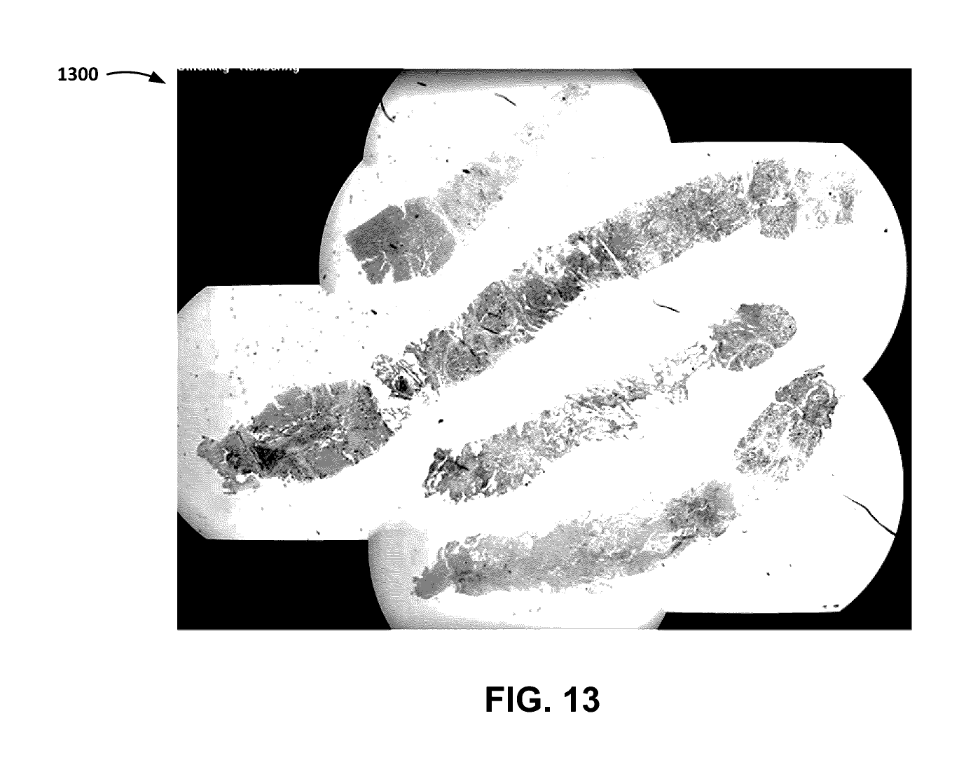

FIG. 12 is an image 1200 of an illustrative sample that includes a path 1204 to piece together the imaged portions 1202A-1202J of the sample, in accordance with embodiments of the disclosure. That is, a Pathfinding algorithm may be performed on the imaged portions 1202A-1202J. The path determined by the Pathfinding algorithm may determine the order in which a combined image (e.g., the combined image 1300 depicted in FIG. 13) can be rendered. In embodiments, each connection may have a certain number of correspondences so the edges are weighted and the ordering is determined by searching for a path in a Maximum Spanning Tree algorithm, starting with the best matching node.

At this point, the transforms between image pairs may be known, but simply adding them together may lead to accumulated errors and misalignments. For example, assume a first, second and third imaged portion of the imaged portions 1202A-1202J are overlapping. Further assume that the first and second imaged portions are well aligned and the second and third imaged portions are well aligned. However, assume the first and third imaged portions are not well aligned. As such, if the alignment between first and third imaged portions is improved, the first and second imaged portions may become less aligned. Accordingly, a solution that reduces the amount of misalignment from adjusting the alignment of the imaged portions 1202A-1202J may be determined. In embodiments, adjusting the alignment of the imaged portions 1202A-1202J may be performed using a Mosaic Optimization algorithm, e.g., a Bundle Adjustment algorithm.

In embodiments, a Bundle Adjustment algorithm may be performed to determine the appropriate solution to reduce the amount of misalignment resulting from adjusting the alignment of the imaged portions 1202A-1202J. Furthermore, in embodiments, lens distortion parameters (e.g., the lens distortion parameters discussed above in relation to FIG. 7A) may be refined for all imaged portions 1202A-1202J. In embodiments, new imaged portions may be added to the mosaic one by one and the distances between all the corresponding features are minimized jointly. Each step of Bundle Adjustment may be an iterative process.

After which, the imaged portions 1202A-1202J may now be well aligned (e.g., geometric differences minimized), but there still may be photometric differences. That is, each image pair has a shared overlap region, but there still may be differences (e.g., on the edges) between the two overlap regions from two imaged portions of the imaged portions 1202A-1202J, even though the two imaged portions are aligned. As such, the relative exposure of each imaged portion may be adjusted to reduce the differences between the imaged portions 1202A-1202J. To adjust the relative exposure of each imaged portion so the photometric differences between the imaged portions 1202A-1202J may be reduced, photometric models (e.g., Vignetting and/or Chromatic Aberration algorithms) may be used.

In embodiments, the imaged portions 1202A-1202J may also be loaded one by one and blended on a common compositing surface. Image blending may be a two-part process. First, a mask may be generated that determines what pixels belong to the sample and what pixels belong to portions outside of the field of view. In embodiments, a transition area may be used at the edges of the overlap portion to result in smoother blending. In embodiments, a blending mask may be found that reduces the difference between the image and canvas in the overlap region. As such, a contour that avoids making visible edges or transitions may be formed. In embodiments, a graph cut search over image segments may be used so that the segments are computed using a watershed transform such that each segment contains similar pixels.

In embodiments, the second part of the two-part process may be scale decomposition of the image, the canvas and the blending mask. In embodiments, each scale is processed separately and the result is collapsed back into the final blended image. In embodiments, the blending algorithm may be multi-band blending. Using multi-band blending, fine details should be blended with high frequency (e.g., sharp), while seams and coarse features may be blended by blurring the seams and coarse features using, for example, a blur radius corresponding to the seams and course features scales. As such, optimal size of a feathering mask for each scale may be obtained.

In embodiments, the combined image is copied to a common compositing surface. FIG. 13 is an image of an illustrative combined image 1300, in accordance with embodiments of the disclosure. In embodiments, each imaged portion and all the seams of the combined image 1300 may be kept track of, so that further blending may be performed. In embodiments, the combined image 1300 may be compared to the scouting image and overlaid with the scouting image by determining the features of both images and appropriate scaling and under-laying of the scouting image with the combined image 1300. In embodiments, the scouting image and combined image 1300 may be overlaid and compared to determine whether any portions of the scouting image were not included in the combined image 1300. In embodiments, the combined image 1300 may be uploaded to a server, user device and/or mobile device (e.g., the server 124, the user device 126 and mobile device 128 depicted in FIG. 1) for viewing.

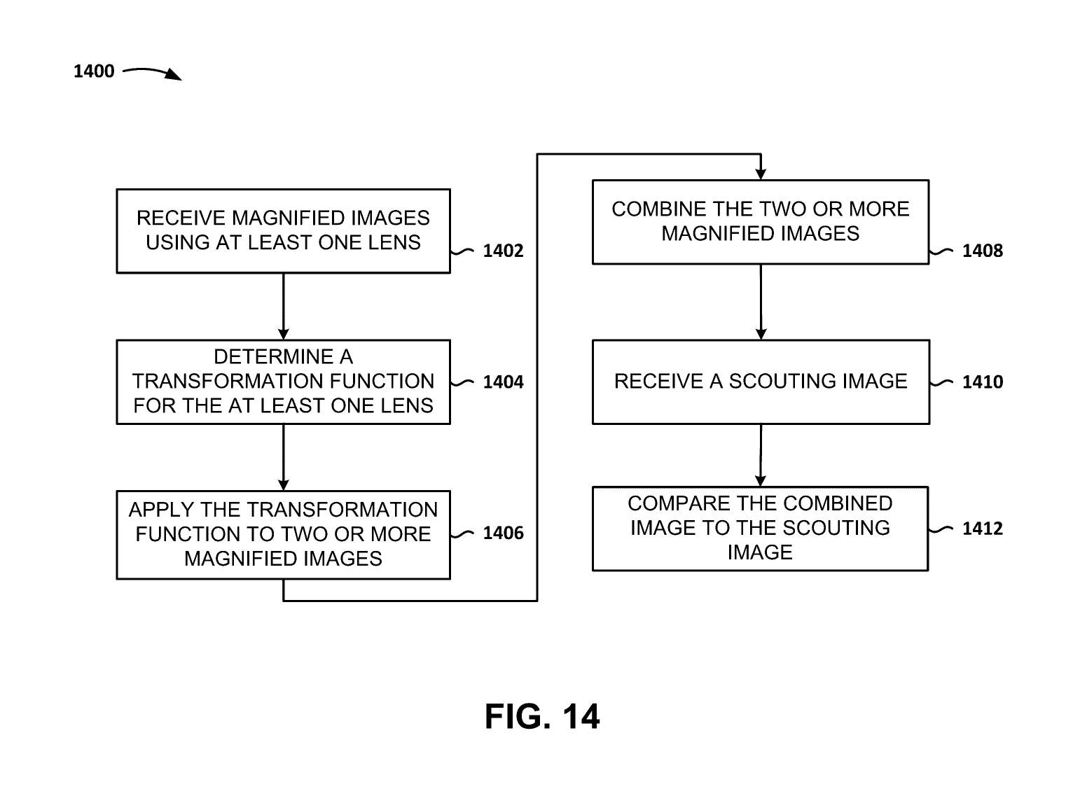

FIG. 14 is a flow diagram of an illustrative method 1400, in accordance with embodiments of the disclosure. In embodiments, the method 1400 comprises: receiving magnified images of portions of a sample using at least one lens (block 1402). In embodiments, an ocular device (e.g., the ocular device 108 depicted in FIG. 1) may be used to magnify images of portions of a sample; a detector (e.g., the detector 110 depicted in FIG. 1) may be used to detect the magnified images; and a computing device (e.g., the computing device 112 depicted in FIG. 1) may receive the magnified images.

In embodiments, method 1400 further comprises determining a transformation function for the at least one lens (block 1404). In embodiments, determining a transformation function for the at least one lens (block 1404) may be similar to the embodiments described above in FIGS. 7A-7C. For example, in embodiments, determining the transformation function for at least one lens may comprise determining an amount of distortion of a magnified image of a calibration grid (e.g., the calibration grids 702A-702C depicted in FIGS. 7A-7C) and comparing the amount of distortion to known parameters of the calibration grid. In embodiments, the known parameters of the calibration grid include at least one of: curvature of one or more lines included in the calibration grid and length of the one or more lines included in the calibration grid.

In embodiments, method 1400 further comprises applying the transformation function to two or more magnified images of the received magnified images (block 1406). By applying the transformation function to a magnified image, any distortion caused by the at least one lens may be reduced. After which, method 1400 comprises combining the two or more magnified images into a combined image (block 1408). In embodiments, combining the two or more magnified images into a combined image (block 1408) may be similar to the embodiments described above in FIGS. 9-13. For example, combining the received two or more magnified images into a combined image may comprise determining a plurality of features included in the two or more magnified images and determining at least one feature of the plurality of features that is included in a first and second image of the two or more magnified images. In embodiments, determining a plurality of features comprises using a Corner Detection algorithm. As another example, combining the two or more magnified images into a combined image may comprise using at least one of: a Mosaic Recognition, algorithm a Pathfinding algorithm, a Mosaic Optimization algorithm and a Color Mismatch Reduction algorithm on the two or more magnified images. As another example, combining the two or more magnified images into a combined image may comprise determining a circular mask in each of the two or more magnified images and removing the circular mask in each of the two or more magnified image.

In embodiments, method 1400 further comprises receiving a scouting image (block 1410). In embodiments, a detector (e.g., the detector 110 depicted in FIG. 1) may detect the scouting image and be received by a computing device (e.g., the computing device 112 depicted in FIG. 1). In embodiments, the scouting image may have some or all of the same features as the scouting image described in relation to FIG. 1 above.

In embodiments, method 1400 may also comprise comparing the combined image to the scouting image (block 1412). In embodiments, comparing the combined image to the scouting image (block 1412) may be performed by determining the features of the scouting image and the combined image and scaling and under-laying the scouting image properly based on the determined features.

FIGS. 15A-15D are illustrative images 1500A-1500D of portions of an eye, in accordance with embodiments of the disclosure. As described above in relation to FIG. 6, a sample (e.g., a person's eye, inner ear, mouth, throat, and/or other orifice) may be imaged using a computing device and/or detector that is set to “burst mode.” In embodiments, a burst mode may capture a plurality of images 1500A-1500D of one or more portions of a sample. Some of these images 1500A-1500D may be in focus and others may be out of focus. For example, the images 1500A, 1500B in FIGS. 15A, 15B are slightly out of focus and the images 1500C, 1500D in FIGS. 15C, 15D are closer to being in focus. In embodiments, after or before a computing device determines which images are in focus (e.g., using the embodiments described above in relation to FIG. 1), a transformation function that determines an amount of lens distortion caused by the lens used to magnify the sample may be determined (e.g., using the embodiments described above in relation to FIGS. 7A-7C). The computing device also determines features (e.g., using the embodiments described above in relation to FIG. 10 above) that are included in the images 1500C, 1500D. For example, when the sample is an eye, the vasculature of the eye, e.g., the vasculature 1502C, 1502D, may be identified as one or more features. After features are identified in the images 1500C, 1500D, a computing device may combine the images together using, for example, the embodiments described above in relation to FIGS. 11-13. FIG. 16 depicts a combined image 1600 of a portion of the in-focus images 1500C, 1500D of the sample.

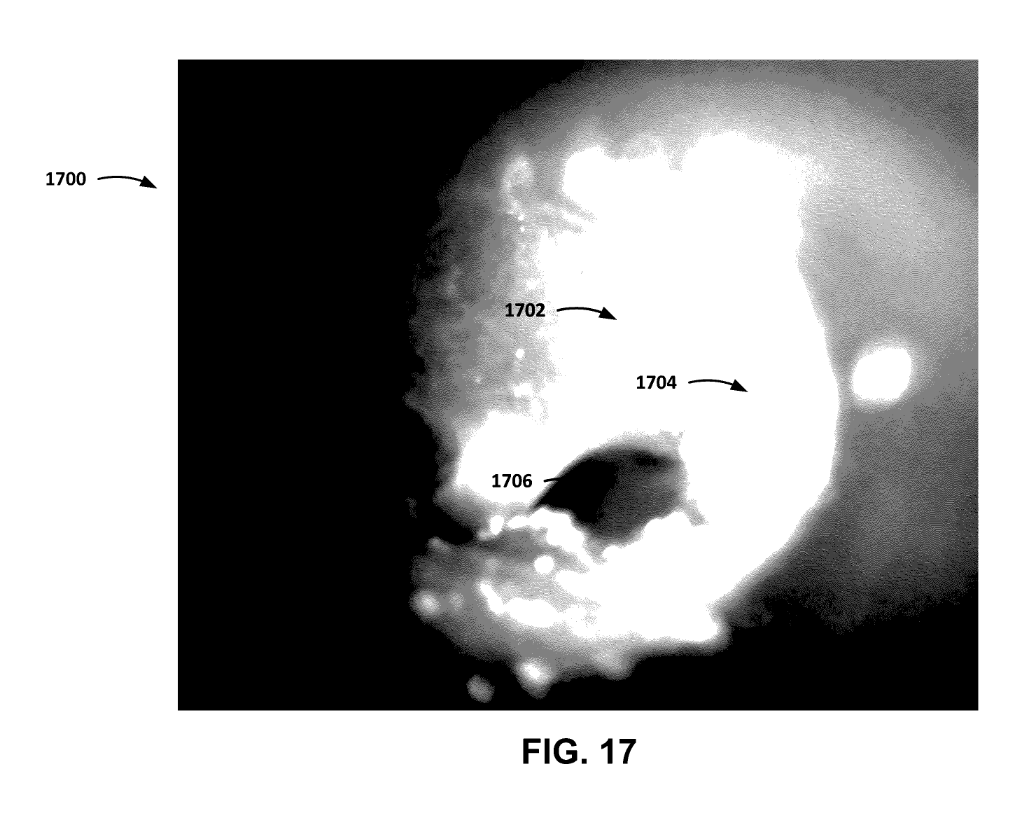

Similar to an eye being imaged, a person's inner ear, mouth, throat and/or other orifice may be imaged using the embodiments described herein. FIG. 17 is an illustrative image 1700 of an inner ear, in accordance with embodiments of the disclosure. A transformation function for a lens that produces the magnified image 1700 may be determined using the embodiments described above in relation to FIGS. 7A-7C. A plurality of images, such as image 1700 may be taken. Features in the plurality of images of the inner ear may be identified (e.g., tympanic membrane 1702, external auditory canal 1704, blood 1706 and/or any other features) and combined according to the embodiments described above in relation to FIGS. 10-13.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A system comprising:
an ocular device including at least one lens used to magnify portions of a sample;
a detector configured to detect the magnified portions and produce magnified images of the magnified portions; and
a processing device communicatively coupled to the detector, the processing device configured to:
determine a transformation function for the at least one lens;
receive two or more magnified images;
apply the transformation function to the received magnified images; and
combine the transformed magnified images into a combined image.

2. The system of claim 1, wherein to combine the transformed magnified images into a combined image, the processing device is configured to: determine a plurality of features included in the received magnified images and determine at least one feature of the plurality of features that is included in both a first and second image of the received magnified images.

3. The system of claim 2, wherein to determine features included in the received magnified images, the processing device is configured to use corner detection on the transformed magnified images.

4. The system of claim 1, wherein to combine the transformed magnified images into a combined image, the processing device is configured to perform on the transformed magnified images at least one of: a mosaic recognition algorithm, a pathfinding algorithm, a mosaic optimization algorithm and a color mismatch reduction algorithm.

5. The system of claim 1, wherein to combine the transformed magnified images into a combined image, the processing device is configured to: determine a circular mask in each of the transformed magnified images and remove the circular mask in each of the transformed magnified images.

6. The system of claim 1, wherein to determine the transformation function for the at least one lens, the processing device is configured to: receive a magnified image of a calibration grid from the detector; determine parameters of the magnified image of the calibration grid; and compare the determined parameters to known parameters of the calibration grid.

7. The system of claim 6, wherein the determined and known parameters of the calibration grid include at least one of: curvature of one or more lines of the calibration grid and length of the one or more lines of the calibration grid.

8. The system of claim 6, wherein one or more lines included in the calibration grid extend from substantially a center portion of a field of view of the ocular device to substantially an edge portion of the field of view.

9. The system of claim 1, wherein the detector is configured to detect a scouting image of the sample and the processing device is further configured to: receive the scouting image and compare the scouting image with the combined image.

10. A method comprising:
receiving magnified images of portions of a sample, the images being magnified by at least one lens;
determining a transformation function for the at least one lens;
applying the transformation function to two or more magnified images of the received magnified images; and
combining the two or more transformed images into a combined image.

11. The method of claim 10, wherein combining the two or more transformed images into a combined image comprises: determining a plurality of features included in the magnified images and determining at least one feature of the plurality of features that is included in a first and second image of the magnified images.

12. The method of claim 11, wherein determining a plurality of features comprises using corner detection.

13. The method of claim 10, wherein combining the two or more transformed images into a combined image comprises performing on the two or more magnified images at least one of: a mosaic recognition algorithm, a pathfinding algorithm, a mosaic optimization algorithm and a color mismatch reduction algorithm.

14. The method of claim 10, wherein combining the two or more transformed images into a combined image comprises: determining a circular mask in each of the two or more transformed images and removing the circular mask in each of the two or more transformed imaged.

15. The method of claim 10, wherein determining a transformation function for the at least one lens comprises: receiving a magnified image of a calibration grid; determining parameters of the magnified image of the calibration grid; and comparing the determined parameters to known parameters of the calibration grid.

16. The method of claim 15, wherein the determined and known parameters of the calibration grid include at least one of: curvature of one or more lines of the calibration grid and length of the one or more lines of the calibration grid.

17. The method of claim 10, further comprising: receiving a scouting image; and comparing the scouting image with the combined image.

18. A non-transitory tangible computer-readable storage medium having executable computer code stored thereon, the code comprising a set of instructions that causes one or more processors to perform the following:
receive magnified images of a sample;
receive a magnified image of a calibration grid;
determine parameters of the received magnified image of the calibration grid;
compare the determined parameters to known parameters of the calibration grid;
determine a transformation function based on the comparison; and
apply the transformation function to the received magnified images the sample.

19. The system of claim 18, the processing device further configured to: combine the transformed images into a combined image.

20. The system of claim 19, the processing device further configured to: receive a scouting image and compare the scouting image with the combined image.
